(19) United States
(12) Patent Application Publication
(10) Pub. No.: US 2025/0131508 A1
(43) Pub. Date: Apr. 24, 2025

(54) ARTIFICIAL INTELLIGENCE-BASED SYSTEMS AND METHODS FOR DETERMINING INSURANCE PREMIUM AMOUNT

(71) Applicant: Al Bagiro, Dayton, OH (US)

(72) Inventor: Al Bagiro, Dayton, OH (US)

(21) Appl. No.: 18/492,707

(22) Filed: Oct. 23, 2023

(51) Int. Cl. G06Q 40/08

(52) U.S. Cl. CPC G06Q 40/08

(57) ABSTRACT

A computer-implemented method is disclosed for determining an insurance premium amount. The computer-implemented method includes a step of obtaining, from a remote server, telematics data associated with operation of a vehicle corresponding to a time period. The computer-implemented method includes a step of extracting, based on the telematics data, a driving feature dataset comprising at least one of: a driving behavior dataset, an environmental condition dataset, or a combination thereof. The computer-implemented method includes a step of calculating, based on execution of a trained ensemble model on the extracted driving feature dataset, a risk score indicative of a probability of occurrence of a collision of the vehicle. The computer-implemented method includes a step of determining, based on the calculated risk score, the insurance premium amount. The computer-implemented method includes a step of storing the determined insurance premium amount in a database associated with an insurance service platform.

### TECHNOLOGICAL FIELD

The present disclosure generally relates to the determination of insurance premium amount and more particularly relates to a computer-implemented method and an insurance system for determining an insurance premium amount based on the driver's behavior.

### BACKGROUND

Typically, telematics data refers to the collection and analysis of data from a vehicle's onboard sensors and communication systems. This data generally includes information about the vehicle's speed, location, acceleration, braking, cornering, and other driving behaviors. Telematics data is often used in the insurance industry to determine insurance premiums and policy terms based on an individual driver's behavior. U.S. Pat. No. 11,449,950 B2 issued to Sunil Chintakindi et al. discloses a risk index-based insurance system that includes a risk index module to determine a rate or a cost to insure an average user for a predetermined period. For instance, the risk index module may receive data, such as insurance data from an insurance data store, and locality data from a locality data store, and determine, based on the received data, the cost to insure an average user over a predetermined period.

Another U.S. Pat. No. 11,249,544 B2 issued to Roberto Sicconi et al. talks about a method for usage-based insurance security and privacy, including a method of collecting and storing driver data to automatically monitor driving context where monitoring of context including detection of driver's behavior and attention as well as car parameters, internal and external.

However, there are various shortcomings in the existing and aforementioned prior arts when determining insurance amounts based on telematics data because managing and processing large volumes of telematics data is challenging. Further, understanding the significance of various data points and how they correlate with risk factors is complex.

To address these challenges, this specification recognizes that there is a need for a computer-implemented method and system to utilize machine learning algorithms to process and interpret the telematics data to determine an insurance premium amount.

### BRIEF SUMMARY OF SOME EXAMPLE EMBODIMENTS

Telematics data has emerged as a valuable tool for insurance companies, revolutionizing the way they assess risk and determine insurance premiums. This technology leverages real-time information collected from various sensors and devices installed in vehicles, providing insurers with a deeper understanding of their policyholders' driving behaviors and habits. Despite various advantages, insurance companies face challenges in effectively utilizing telematics data such as processing the telematics data and accurately interpreting the telematics data to determine the insurance premium amount.

In order to solve the foregoing problem, the present disclosure may provide systems and methods that help to present Usage-Based Insurance (UBI) schemes that calculate insurance premium amounts fairly and per mile driven based on actual driving behavior. This not only encourages safer driving habits among drivers but also reduces the likelihood of accidents and breakdowns.

Various embodiments are provided herein for the determination of an insurance premium amount. The determination of the insurance premium amount is based on telematics data collected from Electronic Logging Devices (ELD) attached to the vehicles such as trucks, autonomous vehicles, or driverless vehicles.

Thus, as disclosed herein, the methods and systems describing the determination of the insurance premium amount in various embodiments, utilize vehicle scoring, which examines vehicle condition and performance using telematics data, and predictive vehicle maintenance, which offers maintenance recommendations to prevent vehicle failures. The methods and systems of the present disclosure provide better and more efficient mechanisms to accurately determine a driver's real driving behavior, and thus predict accidents and crashes, and assess the condition of their vehicles, to present dynamic or predictive route pricing.

A system, a computer-implemented method, and an insurance system are provided for determining an insurance premium amount based on the driver's behavior.

In one aspect, a computer-implemented method for determining an insurance premium amount is provided. The computer-implemented method includes a step of obtaining, from a remote server, telematics data associated with operation of a vehicle corresponding to a time period. The computer-implemented method includes a step of extracting, based on the telematics data, a driving feature dataset comprising at least one of: a driving behavior dataset, an environmental condition dataset, or a combination thereof. The computer-implemented method includes a step of calculating, based on execution of a trained ensemble model on the extracted driving feature dataset, a risk score indicative of a probability of occurrence of a collision of the vehicle. The trained ensemble model being trained on a training dataset includes a plurality of subsamples of the driving feature dataset such that each subsample of the plurality of subsamples comprises at least: a common minority class dataset and a varying majority class dataset. The computer-implemented method includes a step of determining, based on the calculated risk score, the insurance premium amount. The computer-implemented method includes a step of storing the determined insurance premium amount in a database associated with an insurance service platform.

The computer-implemented method includes a step of determining a driving score indicative of behavior of a driver of the vehicle, based on a weighted combination of the driving behavior features, and the environmental condition features. The computer-implemented method includes a step of calculating, using the trained ensemble model, the risk score based on the driving behavior features. The computer-implemented method includes a step of building a clustering model to determine a risk segment of the driver of a vehicle. The computer-implemented method includes a step of determining a combined driver score based on the driving score, the risk segment of the driver, and the risk score. The computer-implemented method includes a step of determining the insurance premium amount for the vehicle based on the first combined driver score. The computer-implemented method includes a step of obtaining vehicle condition data of the vehicle corresponding to the time period. The computer-implemented method includes a step of determining a vehicle score based on the vehicle condition data. The computer-implemented method includes a step of computing a second combined driver score based on the vehicle score, the driving score, and the risk score. The computer-implemented method includes a step of determining, based on the second combined driver score, the insurance premium amount for the vehicle. The computer-implemented method includes a step of displaying, via a user interface of the insurance service platform, the insurance premium amount to a user.

In additional method embodiments, the common minority class includes data of collision events and the varying majority class includes a dataset of no collision events.

In additional method embodiments, the trained ensemble model includes a plurality of machine learning models that include but are not limited to a first gradient-boosting model, a second gradient-boosting model, and a neural network.

In additional method embodiments, the risk segment corresponds to one of: a very safe segment, a safe segment, a moderate segment, a subpar segment, and an unacceptable segment.

In additional method embodiments, the clustering model is trained based on a training dataset that comprises a plurality of driving features of different drivers collected over a period of time, to segment the different drivers into a number of segments.

In additional method embodiments, the vehicle condition data comprises one or more of a fuel level state, a battery voltage state, an engine coolant temperature state, an engine coolant level state, an engine oil temperature state, an engine oil pressure state, a transmission oil temperature state, and a tire pressure state.

In additional method embodiments, the driving behavior dataset includes but is not limited to hard acceleration data, very hard acceleration data, extreme acceleration data, hard braking data, very hard braking data, extreme braking data, hard acceleration-cornering data, hard braking-cornering data, over-speeding data, driving hours data, night drive hours data, average speed data, driver camera data, and service hours violation data.

In additional method embodiments, the environmental condition dataset includes but is not limited to harsh weather condition data, dangerous roads driven data, road surface data, and traffic condition data.

In another aspect, a computer-implemented method for determining insurance premiums for an autonomous vehicle is provided. The computer-implemented method comprises obtaining autonomous vehicle data associated with operation of the autonomous vehicle corresponding to a time period. The computer-implemented method further comprises determining, based on the autonomous vehicle data, a plurality of driving features. The computer-implemented method further comprises determining an autonomous vehicle score based on a weighted sum of the plurality of driving features. Further, the computer-implemented method comprises determining, based on the autonomous vehicle score, the insurance premium for the autonomous vehicle.

In additional method embodiments, the autonomous vehicle is a truck.

In additional method embodiments, the plurality of driving features comprises automation level data, driving duration data, mileage traversed data, speed data, nighttime driving data, warning data, vehicle condition data, weather data, road type data, road surface data, U.S. Department of Transportation (DOT) Hours of Service (HOS) data, and traffic data.

In additional method embodiments, the autonomous vehicle data comprises one or more of a fuel level state, a battery voltage state, an engine coolant temperature state, an engine coolant level state, an engine oil temperature state, an engine oil pressure state, a transmission oil temperature state, a cybersecurity state, and a tire pressure state.

In yet another aspect, a computer-implemented method for training a machine learning model to determine a risk score indicative of a probability of occurrence of a collision of a vehicle is provided. The computer-implemented method comprises receiving a training dataset that includes a dataset of a number of collision events and a number of non-collision events for training the machine learning model. The machine learning model is based on a first gradient-boosting model, a second gradient-boosting model, and a neural network. The computer-implemented method comprises generating, based on the training dataset, a first sub-training dataset, a second sub-training dataset, and a third sub-training dataset. The computer-implemented method comprises training, based on the first sub-training dataset, the first gradient-boosting model to determine a first probability of the occurrence of the collision. The computer-implemented method further comprises training, based on the second sub-training dataset, the second gradient-boosting model to determine a second probability of the occurrence of the collision. Further, the computer-implemented method comprises training, based on the third sub-training dataset, the neural network to determine a third probability of the occurrence of the collision. The computer-implemented method comprises determining the risk score based on a weighted average of the first probability of the occurrence of the collision, the second probability of the occurrence of the collision, and the third probability of the occurrence of the collision.

In yet another aspect, an insurance system is provided. The insurance system includes a memory and a computer processor. The memory is configured for storing program instructions, a trained ensemble model, and telematics data associated with operation of a vehicle for a predetermined time period. The computer processor is coupled to the memory and executing the program instructions for executing a method that includes retrieving the telematics data associated with operation of the vehicle corresponding to a time period. The method includes extracting, based on the telematics data, a driving feature dataset comprising at least one of: a driving behavior dataset, an environmental condition dataset, or a combination thereof. The method further includes calculating, based on execution of the trained ensemble model on the extracted driving feature dataset, a risk score indicative of a probability of occurrence of a collision of the vehicle. The trained ensemble model being trained on a training dataset includes a plurality of subsamples of the driving feature dataset such that each subsample of the plurality of subsamples comprises at least: a common minority class dataset and a varying majority class dataset. The method further includes determining, based on the calculated risk score, an insurance premium amount. The method further includes storing the determined insurance premium amount in the memory.

In additional system embodiments, the common minority class includes data of collision events and the varying majority class includes a dataset of no collision events.

In additional system embodiments, the trained ensemble model includes a plurality of machine learning models that include but are not limited to a first gradient-boosting model, a second gradient-boosting model, and a neural network.

Accordingly, one advantage of the present invention is that it enhances data processing speed through a unified analytics engine. In one embodiment, this unified analytics engine represents the latest platform for efficient, real-time distributed computing workloads on large datasets, optimizing the ETL (extract, transform, load) process. This engine efficiently processes millions of raw telematics records. This strategic choice significantly improves data processing efficiency. The distributed computing capabilities of the unified analytics engine ensure that massive volumes of data are processed in parallel, leveraging the combined computational power of multiple machines. This distributed architecture not only reduces processing time but also mitigates bottlenecks often encountered in single-node systems when handling extensive datasets. The data processing pipelines are designed to easily scale up for handling billions of records.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described exemplary embodiments of the disclosure in general terms, reference will now be made to the accompanying drawings, which are not necessarily drawn to scale, and wherein:

FIG. 1 illustrates a block diagram showing an example architecture of an insurance system for determining an insurance premium amount, in accordance with one or more example embodiments.

FIG. 2 illustrates an exemplary block diagram of an insurance system, in accordance with one or more example embodiments.

FIG. 3 illustrates a tabular representation of telematics data, in accordance with one or more example embodiments.

FIG. 4 is a flowchart of a method to compute driver score, in accordance with one or more example embodiments.

FIG. 5 is a flowchart of a method to compute risk score, in accordance with one or more example embodiments.

FIG. 6 illustrates a block diagram of using various machine learning models to train an ensemble model, in accordance with one or more example embodiments.

FIG. 7 illustrates a graphical representation of a result of the SHAP (SHapley Additive exPlanations) model built using predictions from the LGBM model, in accordance with one or more example embodiments.

FIG. 8 illustrates a graphical representation of individual feature contributions made by the SHAP model when predicting that a driver would not be involved in a collision, in accordance with one or more example embodiments.

FIG. 9 illustrates a graphical representation of individual feature contributions made by the SHAP model when predicting that a driver would be involved in a collision, in accordance with one or more example embodiments.

FIG. 10 is a dashboard of a collision prevention model explainer, in accordance with one or more example embodiments.

FIG. 11 is a dashboard of individual features contribution to a specific prediction made by a machine learning model, in accordance with one or more example embodiments.

FIG. 12 illustrates a block diagram of a clustering model, in accordance with one or more example embodiments.

FIG. 13 illustrates a block diagram of a vehicle score model, in accordance with one or more example embodiments.

FIG. 14 is a flowchart of an anomaly detection process, in accordance with one or more example embodiments.

FIG. 15 is a flowchart of a process to compute an Autonomous Truck (AT) score, in accordance with one or more example embodiments.

FIG. 16 illustrates a perspective view of a scalable cloud hosting architecture of the insurance system, in accordance with one or more example embodiments.

FIG. 17 illustrates an exemplary user interface of a driver scoreboard, in accordance with one or more example embodiments.

FIG. 18 illustrates a tabular representation of driver tools and a graphical representation of all model risk scores, in accordance with one or more example embodiments.

FIG. 19 illustrates an exemplary user interface of a fleet dashboard, in accordance with one or more example embodiments.

FIG. 20 illustrates a tabular representation of computations of the risk score and the vehicle score, in accordance with one or more example embodiments.

FIG. 21 illustrates an exemplary user interface of a vehicle scorecard, in accordance with one or more example embodiments.

FIG. 22 illustrates an exemplary chat interface, in accordance with one or more example embodiments.

FIG. 23 illustrates an exemplary geographical user interface of autonomous vehicle law and incident information, in accordance with one or more example embodiments.

FIG. 24 illustrates an exemplary user interface of incident information, in accordance with one or more example embodiments.

FIG. 25 illustrates an exemplary user interface of autonomous vehicle law in various states, in accordance with one or more example embodiments.

FIG. 26 is a flowchart of a computer-implemented method for determining an insurance premium amount, in accordance with one or more example embodiments.

FIG. 27 is a flowchart of a computer-implemented method for determining insurance premium for an autonomous vehicle, in accordance with one or more example embodiments.

FIG. 28 is a flowchart of a computer-implemented method for training a machine learning model to determine a risk score indicative of a probability of occurrence of a collision of a vehicle, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, and/or stored in accordance with embodiments of the present disclosure. Thus, the use of any such terms should not be taken to limit the spirit and scope of embodiments of the present disclosure.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer-readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network devices, and/or other computing devices.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the scope of the present disclosure. Further, it is to be understood that the phraseology and terminology employed herein are for the purpose of the description and should not be regarded as limiting. Any heading utilized within this description is for convenience only and has no legal or limiting effect.

An insurance system, a method, and a computer program product are provided for determining an insurance premium amount. The insurance system and method use telematics data collected from devices in trucks (ELD devices) to understand how a driver behaves while driving. This information is then used to decide how much the driver should pay for their insurance. If the driver is safe and cautious, their insurance cost will be lower because they pose less risk. Thus, the better the driver's behavior, the less they have to pay for insurance.

Various embodiments are provided herein for determining an insurance premium amount by using a driver scoring model, a driver clustering model, and a driver risk score. The driver scoring model assigns a score to each driver based on their driving behavior and other relevant external factors. The driver would be assigned a daily driver score. The higher the score, the better would be the driving behavior and lower scores indicate that the driver has driven more or driven rashly. The driver clustering model is a risk segmentation model that groups drivers' behavior into different risk segments. Further, the driver risk score represents the probability that a driver will get involved in a collision or a dangerous event based on his driving behavior. In addition to assessing driver behavior, the present insurance system and method assess vehicle behavior and recommend vehicle maintenance if required.

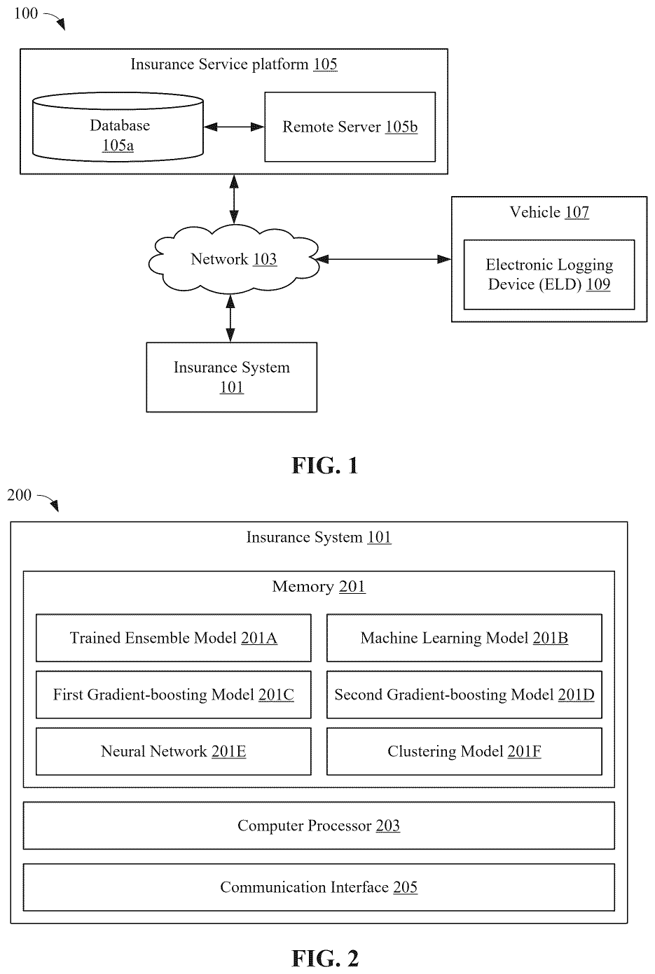

FIG. 1 illustrates a block diagram 100 showing an example architecture of an insurance system 101 for determining an insurance premium amount, in accordance with one or more example embodiments. As illustrated in FIG. 1, the block diagram 100 may comprise the insurance system 101, a network 103, and insurance service platform 105. The insurance service platform 105 may further comprise a database 105a and a remote server 105b (also referred to as a telematics server 105b, OEM server 105b, or a server 105b associated with an insurance provider). The components described in the block diagram 100 may be further broken down into more than one component such as one or more sensors or applications in the vehicle 107 and/or combined in any suitable arrangement. Further, it is possible that one or more components may be rearranged, changed, added, and/or removed without deviating from the scope of the present disclosure.

In various embodiments, the remote server 105b may receive the telematics data from an electronic logging device (ELD) 109 integrated into the vehicle 107 over the network 103. In various embodiments, the vehicle 107 may be an autonomous vehicle, a semiautonomous vehicle, or a manually operated vehicle. In some embodiments, the ELD 109 automatically records driving time and Hours of Service (HOS) records, as well as captures data on the vehicle's engine, movement, and miles driven. Further, the ELD 109 keeps drivers and dispatchers informed of driver status in real-time to support fleet compliance, inspections, and planning. In an embodiment, the ELD 109 includes a vehicle tracking device that connects to the vehicle, a fleet management software, and a mobile application. In some embodiments, the insurance system 101 may be the remote server 105b of the insurance service platform 105 and therefore may be co-located with or within the insurance service platform 105. For example, the insurance system 101 may be embodied as a cloud-based service, a cloud-based application, a cloud-based platform, a remote server-based service, a remote server-based application, a remote server-based platform, or a virtual computing system. In some other embodiments, the insurance system 101 may be an OEM (Original Equipment Manufacturer) cloud. The OEM cloud may be configured to anonymize any data received from the insurance system 101, such as the vehicle, before using the data for further processing, such as before sending the data to the insurance service platform 105. In each of such embodiments, the insurance system 101 may be communicatively coupled to the components shown in FIG. 1 to carry out the desired operations and wherever required modifications may be possible within the scope of the present disclosure.

In various embodiments, the insurance system 103, the insurance service platform 105, and the vehicle 107 are connected over the network 103 for data transmission. The network 103 may be wired, wireless, or any combination of wired and wireless communication networks, such as cellular, Wi-Fi, internet, local area networks, or the like. In some embodiments, the network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The database 105a may include data about the insurance premium amount. The database 105a may additionally include data about driving behavior, road conditions, and vehicles. The database 105a may be communicatively coupled to the remote server 105b. The remote server 105b may comprise one or more processors configured to process requests received from the insurance system 101. The processor may fetch driving behavior data and insurance premium amount data from the database 105a and transmit the same to the insurance system 101 in a format suitable for use by the insurance system 101.

FIG. 2 illustrates an exemplary block diagram 200 of an insurance system 101, in accordance with one or more example embodiments. FIG. 2 is explained in conjunction with FIG. 1. The insurance system 101 includes a memory 201, a computer processor 203, and a communication interface 205. The memory 201 is configured for storing program instructions, a trained ensemble model 201A, and telematics data associated with operation of the vehicle 107 for a predetermined time period. The computer processor 203 is coupled to the memory 201 and executes the program instructions for executing a method that includes retrieving the telematics data associated with operation of the vehicle 107 corresponding to a time period. The method includes extracting, based on the telematics data, a driving feature dataset comprising at least one of: a driving behavior dataset, an environmental condition dataset, or a combination thereof. The method further includes calculating, based on execution of the trained ensemble model 201A on the extracted driving feature dataset, a risk score indicative of a probability of occurrence of a collision of the vehicle 107. The trained ensemble model 201A being trained on a training dataset includes a plurality of subsamples of the driving feature dataset such that each subsample of the plurality of subsamples comprises at least: a common minority class dataset and a varying majority class dataset. In additional system embodiments, the common minority class includes data of collision events and the varying majority class includes a dataset of no collision events. The method further includes determining, based on the calculated risk score, an insurance premium amount. The method further includes storing the determined insurance premium amount in the memory 201. In additional system embodiments, the trained ensemble model 201A includes a plurality of machine learning models 201B that include but are not limited to a first gradient-boosting model 201C, a second gradient-boosting model 201D, and a neural network 201E.

The calculation of a risk score, which represents the probability of a collision occurring in a vehicle process of FIG. 2 improves computer performance as it is determined based on the execution of a trained ensemble model (201A) on a dataset of driving features. The elements contributing to improved computer performance or speed in this scenario are:

Parallelism: Calculating a risk score using an ensemble model typically involves running multiple machine learning models in parallel or sequentially. The use of ensemble methods allows for parallel processing, where different models within the ensemble can be executed simultaneously. This parallelism can lead to a significant improvement in computation speed, as multiple models are working concurrently.

Optimized Model: The description mentions that the trained ensemble model (201A) is composed of multiple machine learning models, including gradient-boosting models and a neural network. Ensuring that these models are optimized for performance can significantly speed up the prediction process. Model optimization may include using efficient algorithms, proper hyperparameter tuning, and model compression techniques.

Data Sampling: The description specifies that the ensemble model is trained on subsamples of the driving feature dataset. Using subsamples that include a common minority class dataset and a varying majority class dataset is a common technique for handling imbalanced datasets. It can lead to faster model training and inference, as it reduces the computational load associated with analyzing the full dataset.

Batch Processing: Depending on the dataset size and the available computational resources, batch processing can be employed to improve performance. Instead of processing the entire dataset in one go, the dataset can be divided into smaller batches, and risk scores can be calculated in a batch-wise manner. This can lead to a more efficient use of memory and processing resources.

Caching: Caching intermediate results or frequently used data can reduce the need for redundant calculations. If certain data is repeatedly accessed during the risk score calculation, it can be stored in memory for quicker retrieval.

Asynchronous Execution: With the system architecture, parts of the process can be executed asynchronously, allowing the system to perform other tasks while waiting for the risk score calculation to complete.

The process of FIG. 2 improves computer performance or speed in this implementation involves a combination of parallel processing, hardware optimization, data management techniques, and algorithmic choices. These strategies help to make the risk score calculation process faster and more efficient, which is particularly needed in real-time or near-real-time applications like determining insurance premiums based on driving behavior.

In various embodiments, the memory 201 includes a clustering model 201F. The method further includes building a clustering model to determine a risk segment of the driver of the vehicle 107. The method further includes determining a combined driver score based on the driving score, the risk segment of the driver, and the risk score. The method further includes determining the insurance premium amount for the vehicle 107 based on the first combined driver score. The clustering model 201F is trained based on a training dataset that comprises a plurality of driving features of different drivers collected over a period of time, to segment the different drivers into a number of segments.

According to some embodiments, each of the models 201A-201F may be embodied in the memory 201. The computer processor 203 may retrieve computer program code instructions that may be stored in the memory 201 for the execution of computer program code instructions, which may be configured for determining the driving direction.

The computer processor 203 may be embodied in a number of different ways. For example, the computer processor 203 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field-programmable gate array), a microcontroller unit (MCU), a hardware accelerator, a special-purpose computer chip, or the like. As such, in some embodiments, the computer processor 203 may include one or more processing cores configured to perform independently. A multi-core processor may enable multiprocessing within a single physical package. Additionally, or alternatively, the computer processor 203 may include one or more processors configured in tandem via the bus to enable independent execution of instructions, pipelining, and/or multithreading.

Additionally, or alternatively, the computer processor 203 may include one or more processors capable of processing large volumes of workloads and operations to provide support for big data analysis. In an example embodiment, the computer processor 203 may be in communication with the memory 201 via a bus for passing information to insurance service platform 105. The memory 201 may be non-transitory and may include, for example, one or more volatile and/or non-volatile memories. In other words, for example, the memory 201 may be an electronic storage device (for example, a computer-readable storage medium) comprising gates configured to store data (for example, bits) that may be retrievable by a machine (for example, a computing device like the computer processor 203). The memory 201 may be configured to store information, data, content, applications, instructions, or the like, to enable the computer processor 203 to carry out various functions in accordance with an example embodiment of the present disclosure. For example, the memory 201 may be configured to buffer input data for processing by the computer processor 203. As exemplarily illustrated in FIG. 2, the memory 201 may be configured to store instructions for execution by the computer processor 203. As such, whether configured by hardware or software methods, or by a combination thereof, the computer processor 203 may represent an entity (for example, physically embodied in circuitry) capable of performing operations according to an embodiment of the present disclosure while configured accordingly. Thus, for example, when the computer processor 203 is embodied as an ASIC, FPGA, or the like, the computer processor 203 may be specifically configured hardware for conducting the operations described herein. Alternatively, as another example, when the computer processor 203 is embodied as an executor of software instructions, the instructions may specifically configure the computer processor 203 to perform the algorithms and/or operations described herein when the instructions are executed. However, in some cases, the computer processor 203 may be a processor-specific device (for example, a mobile terminal or a fixed computing device) configured to employ an embodiment of the present disclosure by further configuration of the computer processor 203 by instructions for performing the algorithms and/or operations described herein. The computer processor 203 may include, among other things, a clock, an arithmetic logic unit (ALU), and logic gates configured to support the operation of the computer processor 203.

In some embodiments, the computer processor 203 may be configured to provide Internet-of-Things (IoT) related capabilities to users of insurance system 101, where the users may be a traveler, a driver of the vehicle, and the like. In some embodiments, the users may be or correspond to an autonomous or semi-autonomous vehicle. The insurance system 101 may be accessed using the communication interface 205. The communication interface 205 may provide an interface for accessing various features and data stored in the insurance system 101. For example, the communication interface 205 may comprise an I/O interface which may be in the form of a GUI, a touch interface, a voice-enabled interface, a keypad, and the like.

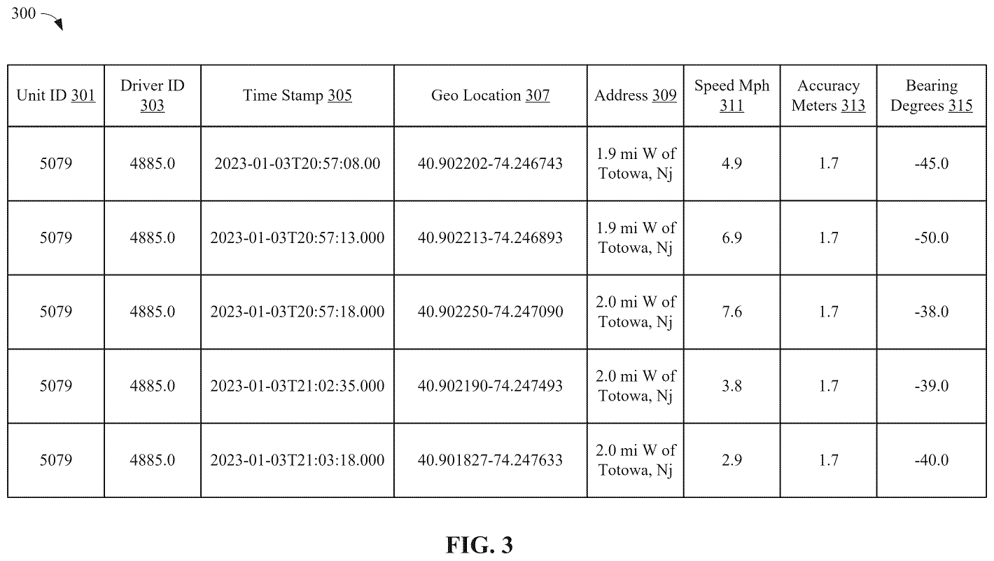

FIG. 3 illustrates a tabular representation 300 of telematics data, in accordance with one or more example embodiments. During the experiment, for building a driver score calculation model, the telematics data is collected from various drivers for about four months. The telematics data was captured at a five-second interval as the driver drove. The telematics data would be captured only when the driver is driving. The features include a timestamp 305 at which the data was captured, geolocation 307 and address 309 of the place the driver was traveling, speed 311, odometer readings, engine hours, accuracy meters 313, and bearing degrees 315. FIG. 3 depicts a small sample of the dataset. DriverID 303 corresponds to a particular driver and UnitID 301 corresponds to the device installed in his vehicle. The initial dataset was in a raw format and a preprocessing and aggregation was performed to transform the raw data in the format required for extracting the required features.

After doing the required preprocessing, the data is aggregated for each driver for a single day i.e., in the case of a driver 4885. FIG. 3 contains the telematics data recorded on 2023 Jan. 3 for driver 4885. As shown, the data is recorded at 5-second intervals. This data will be aggregated for a single day i.e., 2023 Jan. 3. The reason for aggregation is to extract day-level features that would represent the driver's behavior. In an embodiment, the insurance system 100 evaluates the driver's behavior on a per-day basis.

The features to be extracted for identifying driver behavior are classified into multiple categories such as acceleration events, braking events, bearing cornering events, over speeding events, common features, harsh weather events, dangerous roads, road surface conditions, traffic conditions, hours of service (HOS) violations, and driver behavior (camera events).

In an embodiment, the acceleration events are designed to detect instances of aggressive acceleration made by drivers on a daily basis, and these events are classified into three categories 1) hard acceleration, 2) very hard acceleration, and 3) extreme acceleration.

In an embodiment, the hard acceleration event is identified when a driver is traveling at a speed between 30 mph and 60 mph and accelerates by more than 12 mph within the next 5 seconds. For example, if a driver is traveling at a speed of 35 mph, and their speed increases to 47 mph or above within the next 5 seconds, it will be classified as a hard acceleration event. This event will be given less weightage (in the driver score formula) compared to other acceleration events.

The system considered the threshold of 12 mph within 5 seconds for hard acceleration events based on telematics data of about 30,000 drivers. By plotting a histogram of the accelerations made by all drivers while traveling at speeds in the range of 30-50 mph, it is found that 99% of the accelerations were within the range of −7 to 8 mph. Therefore, an acceleration of 12 mph or more within 5 seconds will be a highly improbable event to occur. Hence it will be treated as a hard acceleration event.

In an embodiment, a very hard acceleration event is identified when a driver is traveling at a speed above 60 mph and accelerates by more than 7 mph (but less than 12 mph) within the next 5 seconds. For example, if a driver is traveling at a speed of 55 mph, and their speed increases to 62 mph or above within the next 5 seconds, it will be classified as a very hard acceleration event. This event will be given slightly more weightage than a hard acceleration event. The system considered the threshold of 7-10 mph within 5 seconds for very hard acceleration events like the previous methodology. By plotting a histogram of the accelerations made by all drivers while traveling at speeds above 50 mph, it is found that 99% of the accelerations were within the range of −3 to 5 mph. Therefore, an acceleration above 7 mph or more within 5 seconds is slightly an improbable event. Hence it will be considered a very hard acceleration event.

In an embodiment, the extreme acceleration event is identified when a driver is traveling at a speed above 60 mph and accelerates by more than 12 mph within the next 5 seconds. For example, if a driver is traveling at a speed of 55 mph, and their speed increases to 65 mph or above within the next 5 seconds, it will be classified as an extreme acceleration event. This event will be given the highest weightage among acceleration events.

It was observed that when a driver is traveling above 50 mph, 99% of the acceleration values lie in the range of −3 to 5 mph. An acceleration in the range of 7-10 mph was considered very hard acceleration. An acceleration exceeding 10 mph will be considered an extreme acceleration event.

In an embodiment, the braking events are designed to detect instances of aggressive braking made by drivers on a per-day basis, and like acceleration events these events are classified into three categories: 1) hard braking, 2) very hard braking, and 3) extreme braking.

In an embodiment, the hard braking event is detected when a driver traveling at a speed between 30 mph and 60 mph applies brake and the vehicle speed reduces by more than 12 mph within the next 5 seconds. For example, if a driver is traveling at a speed of 35 mph, and the speed reduces to 23 mph or below within the next 5 seconds, it will be classified as a hard braking event. This event will be given less weightage among braking events. When a driver is traveling at a speed between 30-60 mph, 99% of the acceleration values are −7 to 8 mph. The inclusion of the gap between −7 mph and −12 mph is intended to specifically capture extreme events. Hence, a deceleration is considered below 12 mph as a hard braking event.

In an embodiment, a very hard braking event is detected when a driver traveling at a speed more than 60 mph and applying brake, and the vehicle speed reduces in a range of 7-12 mph within the next 5 seconds. For example, if a driver is traveling at a speed of 75 mph, and the speed reduces to 67 mph or below within the next 5 seconds, it will be classified as a very hard braking event. This event will be given the second most weightage among braking events. When a driver is traveling at a speed above 60 mph, 99% of the acceleration values −3 to 5 mph. Hence, a deceleration is considered in the range of 7-12 mph as a very hard braking event.

In an embodiment, the extreme braking event is detected when a driver traveling at a speed more than 60 mph, applies brake and the vehicle speed reduces to 12 mph or above within the next 5 seconds. For example, if a driver is traveling at a speed of 75 mph, and the speed reduces to 60 mph or below within the next 5 seconds, it will be classified as an extreme braking event. This event will be given the highest weightage among braking events. When a driver is traveling at a speed above 60 mph, 99% of the acceleration values are between −3 to 5 mph. In this case, a deceleration is considered above 12 mph as an extreme braking event.

In an embodiment, the bearing cornering events are designed to detect instances of aggressive or harsh turnings made by drivers on a per-day basis. The column “BearingDegrees” in the telematics dataset represents the vehicle's heading or direction of travel, measured as an angle in degrees with respect to true north. The difference in the bearing degrees between two timestamps can be used to detect whether the driver has made a turn or not. For instance, if the bearing degree of the driver at a specific time is 180 degrees and after 5 seconds it changes to 80 degrees, this indicates a turn has been made and the angle between the two readings is 100 degrees.

The bearing cornering events are classified into two categories: 1) accelerating while turning: when a driver is making a turn and during the turn if the speed of the vehicle increases by more than 12 mph, it is considered as a harsh turning or cornering, and 2) braking while turning: when a driver is making a turn and during the turn if the driver applies brake and the speed of the vehicle reduces by more than 12 mph, it is considered as a harsh turning. It is assumed that during a turn, a skilled driver would remain attentive and avoid sudden changes in speed, opting instead for a gradual increase or decrease in the vehicle's speed. A threshold of 12 mph is considered for these computations. When a driver is making a turn, 99% of the acceleration values are in the range of −10 to 8 mph.

In an embodiment, the over speeding events are designed to calculate the time a driver has spent driving above the safe speed limits. The maximum speed limit for trucks in most states in the USA is in the range of 70-75 mph. Hence travelling above these speed limits would be highly dangerous. For example, the system tracks the total time spent by a driver traveling in the range of 85 to 100 mph. Further, the system tracks the total time spent by a driver traveling above 100 mph. The over speeding events would weigh more compared to the previous features in the driver's score.

In an embodiment, the common features are designed to aggregate for a driver for each day such as: a) total driving hours: this feature measures the total hours travelled by a driver in a single day. b) Total night hours: This feature calculates the total number of hours the driver has travelled at night. The criteria considered for night travel is 12 am to 5 am. c) Average speed: This feature measures the average speed at which a driver has travelled during a particular day.

In an embodiment, the harsh weather events are designed to determine if a driver has been driving under hazardous weather conditions, such as heavy rain or fog, which can increase the likelihood of accidents. Specifically, this feature calculates the cumulative duration of time that a driver has spent driving in such challenging weather conditions. In an exemplary embodiment, a third-party API provider called WeatherAPI is used to get the weather at a place based on geo-location (latitude and longitude) and time. The present insurance system would be finding out the weather conditions for a driver at a particular location he was travelling in at the end of every hour. In this manner, the total time spent by a driver travelling in harsh weather conditions throughout the day is calculated. Based on the GeoLocation and TimeStamp, weather conditions at that corresponding place would be fetched from Weather API.

Examples of harsh weather conditions include but are not limited to blowing snow, blizzards, freezing fog, heavy freezing drizzle, heavy rain, heavy snow, heavy rain showers, torrential rain showers, heavy snow showers, heavy sleet shower, and heavy rain with thunder.

In an embodiment, the dangerous road events are designed to track the number of dangerous highways or sections of highways a driver has encountered during his/her trip. Based on the FMCSA crashes dataset from 2020 to 2022, which includes information on crashes that have taken place in the USA, a list of 40 highways are compiled where most crashes have occurred. Using additional open-source information, the most dangerous sections across these highways are identified.

The current telematics data solely provides geographic location information and addresses in a specific format. However, it does not include details regarding the specific roads a driver is traveling on, nor does it indicate whether they are on a highway or a local road. The present insurance system identifies whether a driver travels through that dangerous section of highway or not. There are two methods to achieve this outcome. In the first method, Haversine distance is used in computing the distance between two geo-locations. This is a cost-effective and a faster method to solve this problem but not the most accurate method. This method helps to identify if a driver passes through any one of the above-mentioned geo locations or passes in close proximity to any one of the above geo locations then it is assumed that the driver was travelling through that dangerous section of the highway. This is where Haversine distance is helpful. The distance between the geo-location a driver travels through and one of the above geo-locations is computed. If the Haversine distance is less than 2 miles, it is considered that the driver was passing through that dangerous section. The present insurance system is considering the number of unique dangerous highways a driver would be passing through in a day.

In the second method, a third-party reverse geocoding API is used to receive the name of the highway, or the road based on geo location using which it is identified if a driver is travelling through a dangerous road or not. The geo location information is transmitted to the reverse geocoding API to fetch the corresponding address. Now, the present insurance system has already collated a list of dangerous roads in the USA. If the address returned by the API matches with one of the roads in the dangerous roads list, then it is concluded that the driver has travelled through that dangerous road, and the insurance system will keep track of the dangerous roads the driver had travelled in a day.

In an embodiment, the road surface conditions events are designed to identify the road surface conditions and traffic conditions of the routes through which a driver has travelled throughout the day. More specifically, one can discern the various states through which a driver traverses in a day. Subsequently, the objective is to ascertain the road conditions and traffic conditions prevalent in those states the driver is traversing. As a result, by the end of the day, it becomes feasible to determine whether a driver encounters states with unfavorable road conditions or states with adverse traffic conditions. Evaluating road conditions encompasses the consideration of three key factors: 1) The proportion of urban and rural Interstate highways in suboptimal condition; 2) The percentage of urban and rural minor, major collector roads, and other principal arterials in subpar condition; 3) The number of fatalities per 100 million vehicle miles traveled.

In an embodiment, the information may be retrieved from the United States Department of Transportation website that maintains a database called Bureau of Transportation Statistics (BTS) where the surface condition of various classes of roads such as Interstate highways, freeways, expressways, etc., spread across the State are available. The road surface quality is measured using a metric called the International Roughness Index (IRI) which assesses a road's overall pavement quality. An IRI index value less than 95 inches/mile represents good road conditions while IRI index values above 171 represent rough road surfaces. With the help of the BTS database, the percentage of roads in bad condition (less than 171) in each State in the USA are identified. The below table shows the State and percentage of urban Interstate highways in bad condition in those States and the percentage of roads other than Interstate highways such as freeways, expressways, and other minor and major collector roads in bad condition. The lower rank indicates that the State has a very low percentage of roads in bad condition. The below table shows the top 5 States with best quality urban Interstate highways.

| | Percentage of urban | | Percentage of | |
|---|---|---|---|---|
| | Interstate roads | | other urban roads | |
| State | in bad condition | Rank | in bad condition | Rank |
| New Hampshire | 0.15 | 1 | 24.49 | 25 |
| North Dakota | 0.98 | 2 | 11.43 | 10 |
| South Carolina | 1.14 | 3 | 14.02 | 14 |
| South Dakota | 1.13 | 4 | 13.80 | 13 |
| Georgia | 1.35 | 5 | 11.13 | 9 |

The below table shows the State and percentage of rural Interstate highways in bad condition in those States and the percentage of roads other than Interstate highways such as minor and major collector roads and other principal arterial roads in bad condition. The below table shows the top 5 States with the best quality rural Interstate highways.

| | Percentage of rural | | Percentage of | |
|---|---|---|---|---|
| | Interstate roads | | other rural roads | |
| State | in bad condition | Rank | in bad condition | Rank |
| Florida | 0.15 | 1 | 6.50 | 12 |
| Nevada | 0.17 | 2 | 12.16 | 22 |
| Rhode Island | 0.27 | 3 | 39.60 | 49 |
| Utah | 0.30 | 4 | 14.44 | 25 |
| Virginia | 0.34 | 5 | 10.57 | 21 |

In addition to the road surface quality, the present system will be using the number of fatalities per 100 million vehicle miles travelled information reported by the Fatality Analysis Reporting System of the US DOT for the year of 2021. The table below shows the States with the most fatalities.

| | Number of fatalities per |
|---|---|
| State | 100 million vehicle miles |
| South Carolina | 2.08 |
| Mississippi | 1.89 |
| Arkansas | 1.80 |
| New Mexico | 1.79 |
| Louisiana | 1.78 |

Now the states on multiple factors are ranked. The system creates an overall ranking by performing a weighted average of individual ranks. While weighing the individual ranks more weightage given for road surface conditions compared to number of fatalities. The table below shows the list of the top 5 best and worst performing States based on road surface conditions and fatalities.

| States with a higher percentage | States with lower percentage |
|---|---|
| of good quality roads and | of good quality roads and |
| fewer fatalities | higher fatalities |
| North Dakota | Hawaii |
| New Hampshire | Delaware |
| Nebraska | West Virginia |
| Minnesota | Louisiana |
| Utah | New Mexico |

Based on this ranking the states are categorized into 5 categories: worse, poor, fair, good, and best. States with the highest ranking (1, 2, 3 . . . ) would be classified as best, and States with the lowest ranking (48, 49, 50 . . . ) would be classified as worst, and so on.

In an embodiment, the traffic conditions are obtained by using average daily traffic per lane in rural and urban interstate highways as well as average daily traffic per lane in rural and urban principal arterial roads as factors for quantifying the traffic congestion in States across the USA. This information is retrieved from the 2020 Highway statistics made available in open source by the Federal Highway Administration under the US DOT. The below table shows the top 5 States with the worst traffic in urban areas arranged in decreasing order of their average daily traffic per lane in urban Interstate highways.

| | Average daily traffic | | Average daily traffic | |
|---|---|---|---|---|
| | per lane in urban | | per lane in urban | |
| State | Interstate highways | Rank | principal roads | Rank |
| California | 18220.36 | 50 | 34091.28 | 50 |
| Maryland | 15857.28 | 49 | 28155.29 | 47 |
| Florida | 14886.05 | 48 | 29807.05 | 48 |
| Connecticut | 14318.37 | 47 | 27644.77 | 46 |
| Texas | 14243.01 | 46 | 24708.51 | 39 |

As the traffic per lane increases the ranking starts worsening. The below table shows the top 5 States with the worst traffic in rural areas arranged in decreasing order of their average daily traffic per lane in rural Interstate highways.

| | Average daily traffic | | Average daily traffic | |
|---|---|---|---|---|
| | per lane in rural | | per lane in rural | |
| State | Interstate highways | Rank | principal roads | Rank |
| New Jersey | 9998.41 | 50 | 17332.45 | 48 |
| South Carolina | 9095.87 | 49 | 11479.11 | 37 |
| Rhode Island | 8980.12 | 48 | 11051.92 | 34 |
| Connecticut | 8707.27 | 47 | 16321.91 | 45 |
| Tennessee | 8638.13 | 46 | 9641.50 | 27 |

Here too, the present system performs a weighted average of the individual ranks to arrive at an overall rank. Based on the final ranking States with lesser and higher traffic congestion are listed below in the table.

| States with lesser | States with the worst |
|---|---|
| traffic congestion | traffic congestion |
| Montana | California |
| North Dakota | Connecticut |
| Alaska | New Jersey |
| Wyoming | Florida |
| South Dakota | Maryland |

Based on this ranking the states are categorized into 5 categories as worse, poor, fair, good, and best. States with the highest ranking (1, 2, 3 . . . ) would be classified as best and States with the lowest ranking (48, 49, 50 . . . ) would be classified as worst, and so on. The below table shows an example of how the States are categorized based on road and traffic conditions.

| State | Road condition | Traffic condition |
|---|---|---|
| Alabama | Fair | Fair |
| Alaska | Fair | Excellent |
| California | Poor | Worse |
| Kentucky | Good | Fair |
| New York | Fair | Good |

The present system would be able to get to the different States the driver has travelled through from the address column of the telematics data. This particular driver had travelled through 2 States (PA and NJ) on that particular day. But he has spent more time travelling through Pennsylvania compared to New Jersey. Hence for a driver for a day the present system would be able to find out the information as listed below.

| | |
|---|---|
| DriverID | 8085 |
| Date | 2023 Jan. 17 |
| Most travelled road conditions | poor |
| Most travelled traffic conditions | fair |
| Time spent in travelling through bad | 2.3 |
| road surface conditions (hours) | |
| Time spent in travelling through bad | 0.8 |
| traffic conditions (hours) | |

The time spent in columns means that this driver has spent around 2 hours in States with bad road conditions while spent around 48 minutes in States with bad traffic conditions.

The Hours-of-service (HOS) rule states the maximum amount of time drivers are permitted to be on duty including driving time, and specifies the number and length of rest periods, to help ensure that drivers stay awake and stay alert. In an embodiment, the HOS violations are designed to identify whether a driver violates the HOS rule on a particular day or not. The below table shows an example of the HOS violations recorded for a driver:

| | | HOS |
|---|---|---|
| Driver ID | Date | Violation |
| 123 | 14 Jun. 2023 | True |
| 123 | 15 Jun. 2023 | False |
| 236 | 14 Jun. 2023 | False |

In an embodiment, the driver behavior (camera events) is captured by various cameras installed in the vehicles. A dual-camera dashcam (recording traffic outside and movements of the driver inside) is installed in the truck of a driver and this camera captures and records events of distracted driving, cell phone usage, fatigue, etc. Events such as distracted driving are very dangerous and including these events in the driver score becomes very crucial. The dashcams integrated with Artificial Intelligence monitor the drivers throughout the trip and if he/she is distracted or uses a cell phone or is tired capture those events and transmit them to the database.

The present system tracks the number of various risky events a driver makes during his/her trip. Examples of risky events include but are not limited to a distracted driving, fatigue, cellphone usage, power disconnected, tampering, possible accident, driver unbelted, obstruction, lane weaving, and tail gating. In an exemplary embodiment, the present system may compute the total number of these risky events a driver makes per day.

The present insurance system and method use various models to compute the driver behavior to determine the insurance premium amounts. These models include a driver scoring model, a clustering model, and a risk score model.

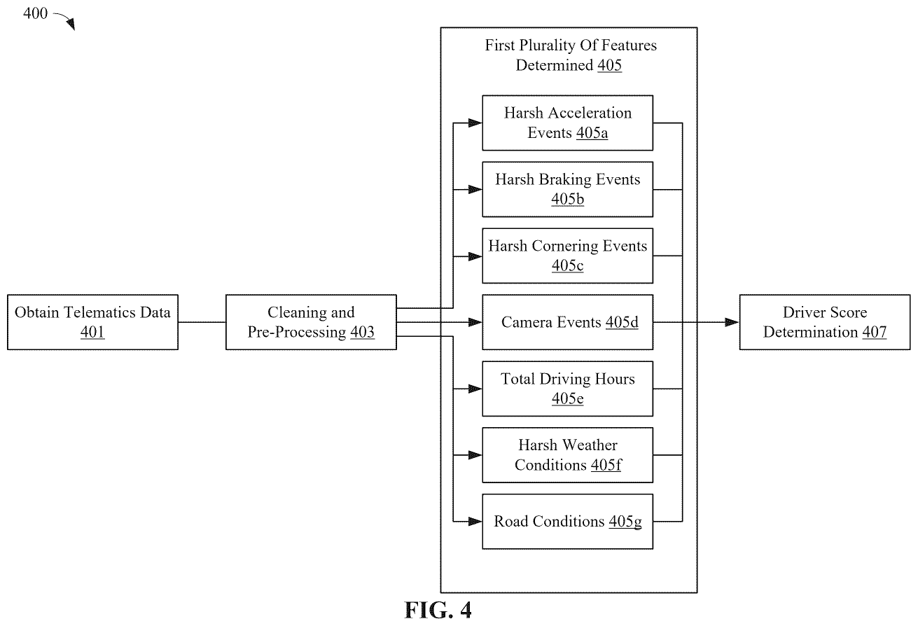

FIG. 4 is a flowchart of a method 400 to compute driver score, in accordance with one or more example embodiments. The method of computing driver score initiates with a step 401 of obtaining telematics data and then at step 403 the telematics data is cleaned and pre-processed. At block 405, a first plurality of features are determined based on the cleaned and pre-processed data. Then at step 407, the driver score is determined. In an embodiment, the first plurality of features include but are not limited to harsh acceleration events 405a, harsh braking events 405b, harsh cornering events 405c, camera events 405d, total driving hours 405e, harsh weather conditions 405f, and road conditions 405g.

In various embodiments, the present system uses a weighted sum-based method to compute the driver score for each day the driver drives. The weighted sum approach calculates a composite score by assigning weights to each individual component. It involves multiplying each component by its corresponding weight and then summing up the weighted values to obtain the final score. The components that would make up the driver score are: 1. Harsh acceleration index; 2. Harsh braking index; 3. Harsh cornering index; 4. Harsh speeding index; 5. Common features; 6. Route score that is based on: a) harsh weather conditions; b) dangerous roads; c. time spent in states with bad road conditions; d) time spent in States with severe traffic congestion; 7. HOS violations; 8. Driver behavior (camera events).

One of the primary advantages of computing the driver score is the ability to assign weights to each feature based on its importance. This allows us to prioritize specific aspects of a driver's behavior and driving habits in the overall evaluation. Additionally, the weighted sum method is highly flexible, enabling us to refine the weights, if necessary, in the future.

Transparency is another crucial aspect of the weighted sum method. By openly disclosing the weights assigned to each component, the present insurance system provides drivers with a clear understanding of how their behavior is being evaluated.

Furthermore, the weighted sum method is straightforward and easy to explain to a layman. Its simplicity makes it accessible to drivers, allowing them to know how their actions contribute to their overall score.

The below examples would explain how each of the components shown in FIG. 4 would be calculated:

Harsh acceleration index: The Harsh acceleration index is comprised of hard accelerations, very hard accelerations, and extreme accelerations. The present system assigns a weightage of 0.5, 0.75, and 1 point to each of the acceleration events recorded respectively.

Harsh braking index: The Harsh braking index is comprised of hard braking, very hard braking, and extreme braking events. The present system assigns a weightage of 1, 1.25, and 2 points to each of the braking events recorded respectively.

Harsh cornering index: The harsh cornering index is comprised of two components which are hard acceleration while turning and hard braking while turning. The present system assigns a weightage of 2 points for each event.

Harsh speeding index: The over speeding index is made up of time spent driving above 85 mph and time spent driving above 100 mph. The present system penalizes 1 point for every 1 minute spent driving above 85 mph while 2 points for every 1 minute spent driving above 100 mph.

Common features: Common feature comprises three features which include total driving hours, total night hours, and average speed. Average speed would be scaled down by 10 while total night hours would be penalized by 1 point. In the case of total driving hours, 1 point would be deducted for each hour of driving until 15 hours but 2 points for drivers who drive above 15 hours per day. This is to penalize for the fact that driving for over 15 hours a day is not safe and is not legal except in certain cases. Additionally, if a driver drives above 15 hours a day but if he/she had used the AdverseDrivingCondition ELD option while driving the present system would not penalize them.

The present disclosure further provides a discount provided to the drivers by the insurance system. Suppose there are two drivers who have 36 hard-braking events in a day. But one driver had driven for 5 hours while the other drove for 10 hours. But both drivers will have the same harsh braking index. The present insurance system solves this issue by two methods.

1. Normalizing the features based on total hours of driving, i.e., based on the above example after normalizing, the first driver would have a harsh braking index of 7.2 (36/5) while the second driver would have a harsh braking index of 3.6 (36/10). However, the problem with this approach is harsh braking or acceleration index values would become too small.

2. The second option would involve scaling down the harsh acceleration index and harsh braking index values for drivers who have driven more than 8 hours a day by a factor of 0.75. Based on the above example, the first driver's harsh braking index would remain the same while the harsh braking index for the second driver would become 27.

The present disclosure further discloses a computation of route penalty. The route scoring penalty is comprised of four parts which include: 1. Harsh weather conditions; 2. Dangerous roads; 3. Bad road conditions; and 4. Bad traffic conditions.

Harsh weather conditions: The present insurance system would not penalize a driver until his/her time spent in harsh weather conditions does not exceed 15 minutes. Otherwise, the present system would scale up the total time spent by the driver in harsh weather conditions by a factor of 5 up to 5 hours of driving and by a factor of 7.5 if the time spent in harsh conditions exceeds 5 hours.

Dangerous roads penalty: The driver would be penalized 1 penalty point for every dangerous road he/she encounters during his/her trip.

Bad road conditions penalty: The present insurance system penalizes drivers for time spent travelling through the states with bad road surface conditions.

Bad traffic conditions penalty: The present insurance system penalizes the drivers for time spent travelling through the States with severe traffic congestion.

Hence route score would be the sum of the harsh weather conditions penalty, dangerous roads penalty and bad road surface conditions, and bad traffic conditions penalty.

The road conditions related penalties are very low because the driver is not in control of the roads, he/she travels through. If they ought to travel by a particular route, they have to travel through it and they have no other options. Hence awarding higher penalties would not be fair to the driver.

HOS violations penalty: a driver would be penalized 2 penalty points for every HOS violation he/she makes per day.

Driver Behavior (Camera events) penalty: There are multiple camera events for which a driver would be penalized, and the penalty is based on the severity of the events.

Based on all the components the final daily driver score would be calculated using: the harsh acceleration index, harsh braking index, harsh cornering index, over speeding index, total driving hours, total night hours, average speed, harsh weather penalty, dangerous road penalty, HOS violation penalty, and driver behavior penalty.

The maximum score would be 900 (it mimics the FICO Insurance Auto Score in the US, which is 250 to 900 points, so all underwriters and consumers will be familiar with the scoring). Hence for a driver, the driver scores would be recorded as below:

| Driver ID | Date | Driver Score |
|---|---|---|
| 123 | 15 Jun. 2023 | 890 |
| 123 | 16 Jun. 2023 | 886 |
| 123 | 17 Jun. 2023 | 872 |

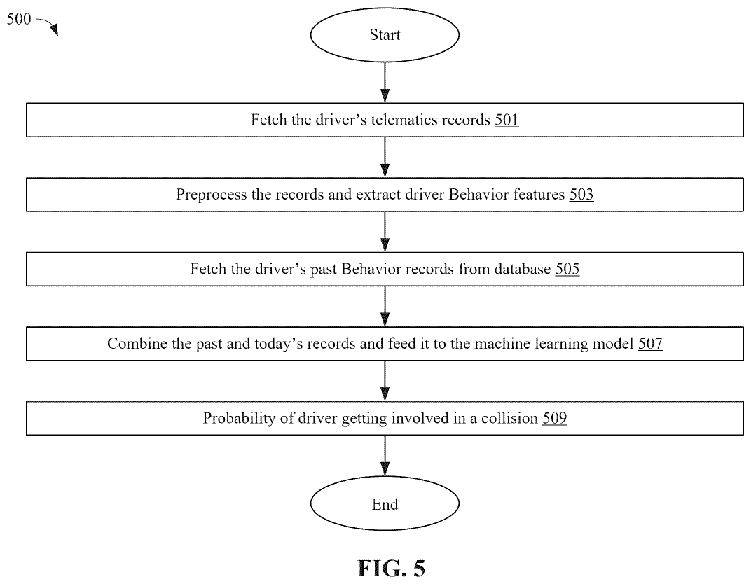

FIG. 5 is a flowchart of a method 500 to compute risk score prediction, in accordance with one or more example embodiments. FIG. 5 is explained in conjunction with FIGS. 1-2. The method 500 includes a step 501 of fetching the driver's telematics records from the ELD devices 109 installed in the vehicles 107. The method 500 includes a step 503 of preprocessing the telematics records and extract driver behavior features by the trained ensemble model 201A. The method 500 includes a step 505 of fetching the driver's past behavior records from the database 105a. The method 500 includes a step 507 of combining the past and today's records and feeding it to the machine learning model 201B. The method 500 includes a step 509 of using a computer processor 203 to compute the probability of the driver getting involved in a collision.

In an embodiment, the present insurance system computes risk score to determine the probability of a driver getting involved in an accident or near-miss event in the future given his recent driving behavior. The present insurance system leverages the help of 10 different supervised advanced machine learning (ML) models such as XGBoost, CatBoost, LGBM, etc., to achieve this outcome. Higher risk scores indicate a higher chance that a driver will get into a collision.

The present disclosure further describes how the risk scores are computed. Assume the below table represents the driving behavior of a driver over 3 days.

| Driver ID | Date | Driving Behavior Features |
|---|---|---|
| 21 | 1 Jul. 2024 | . . . |
| 21 | 2 Jul. 2024 | . . . |
| 21 | 3 Jul. 2024 | . . . |

Taking into consideration his driving behavior on these 3 days the chances/probability of this driver getting into a collision the next time he/she drives would be predicted.

| Driver ID | Date | Features | Risk Score |
|---|---|---|---|
| 21 | 1 Jul. 2024 | . . . | — |
| 21 | 2 Jul. 2024 | . . . | — |
| 21 | 3 Jul. 2024 | . . . | — |
| 21 | 4 Jul. 2024 | . . . | 40% |

Now the present system has the driver behavior on the 4th of July. Taking into consideration the driving behavior on July 2nd, 3rd, and 4th the models would return the probability that a driver would get involved in a collision the next time he/she drives. The risk score may be easily predicted based on just 1 day of driving behavior. But considering 3 days of driving would give us a good understanding of the driver's driving behavior.

The present disclosure further describes how would the features be computed by considering three days of behavior. For better understanding, it is assumed that only information about hard braking events made by a driver in a day is available. The below table represents the count of hard braking events made by a driver in 4 days. The Collision/Risky event column indicates the events that might have been a collision or a near-miss event that might have led to an accident.

| | Number of hard braking | Collision/ |
|---|---|---|
| Day | events (made per day) | Risky event |
| Day 1 | 7 | 0 |
| Day 2 | 4 | 0 |
| Day 3 | 11 | 0 |
| Day 4 | 5 | 1 |

Now the risky event is predicted that occur on the 4th day based on the driving behavior of this driver on the previous 3 days.

| | Number of hard braking | Collision/ |
|---|---|---|
| Day | events (made per day) | Risky event |
| Day 1 | 7 | 0 |
| Day 2 | 5.5 ((7 + 4)/2) | 0 |
| Day 3 | 7.3((7 + 4 + 11)/3) | 0 |
| Day 4 | 5 | 1 |

| | Number of hard | | Probability of getting |
|---|---|---|---|
| | braking events | Collision/ | involved in a collision |
| Day | (made per day) | Risky event | tomorrow (%) |
| Day 1 | 7 | 0 | 23 |
| Day 2 | 5.5 | 0 | 43 |
| Day 3 | 7.3 | 0 | 86 |
| Day 4 | 5 | 1 | — |

The last column in the above table indicates the probability that a driver will get involved in a collision the next day. For example, on the 3rd day, the probability that the driver will get involved in a collision is 86% which is based on the rolling average of the number of the hard braking events the driver had made on the previous 3 days ((7+4+11)/3=7.3).

The features or dependent variables that will be used by the models for predicting a collision will include the earlier features that are calculated such as the number of hard acceleration events made per day, number of hard braking events made per day, total driving hours, etc., In addition to the before computed features, the present system will also be using some additional features which include:
Speed_90—Indicates the speed value at the 90th percentile for a driver on a particular day
Speed_95—Indicates the speed value at the 95th percentile for a driver on a particular day
Speed_99—Indicates the speed value at the 99th percentile for a driver on a particular day
Change_in_velocity_1—Indicates the change in velocity value at the 1st percentile for a driver on a particular day
Change_in_velocity_5—Indicates the change in velocity value at the 5th percentile for a driver on a particular day
Change_in_velocity_95—Indicates the change in velocity value at the 95th percentile for a driver on a particular day
Change_in_velocity_99—Indicates the change in velocity value at the 99th percentile for a driver on a particular day

The features Speed_90, Speed_95, and Speed_99 provide insights into the highest speeds attained by a driver within a day. The earlier computed features such as a number of hard acceleration events give info on how often a driver applies acceleration while the change in velocity features represent how hard the driver accelerates or brakes. While the maximum and minimum values for analysis were used instead of the 1st percentile and 99th percentile, doing so might include outliers that could skew the results. To address this concern, the present system opted for the 1st and 99th percentiles, which provide a more robust representation of the data distribution.

In the prediction task of assessing the likelihood of a driver getting into a collision, the present system encounters a challenge due to the absence of direct information on collision events for a specific day. However, the present system addresses this by using a proxy variable called dangerous braking. This proxy variable is based on instances where a driver moving at a speed greater than 50 mph suddenly applies brakes, resulting in a significant speed reduction, possibly down to 10 or 5 mph, or even bringing the vehicle to a complete stop. It is assumed that such an event indicates a dangerous situation, similar to a collision or a near miss event. Therefore, these dangerous braking events are considered as a substitute variable for accidents or collisions in the analysis. Furthermore, these dangerous braking events indicate near-miss incidents that could have led to accidents. As more telematics data accumulates on accidents or any other dangerous braking events, based on information from drivers or claims, this will serve as a variable for collision analysis.

Based on this methodology the present system has created a dataset that consists of 1 million days of driving behavior with possible collision or risky events observed on 10 k days. This would be a binary classification problem as the present system would be predicting whether a collision happened or not. The outputs would not be in ones or zeros but the probability of a collision happening, i.e., it would be in the range of 0-1 (e.g.: 0.56, 0.34, 0.89). The higher the probability, the higher the chances of an accident, and vice versa. The present system would convert the probability (0.89) to a range of 100 (0.89×100=89) and this would act as the risk score.

In implementation, multiple machine learning models and necessary preprocessing steps were applied at each stage before model training. The models were trained and cross-validated using the Stratified K Fold technique. During the experiment, Optuna for hyperparameter tuning is used. Initially, two approaches were tried for training the model which involves training on the entire dataset and training on a down-sampled dataset.

Further, down sampling is very useful and one of the techniques employed in the case of imbalanced datasets. Class imbalance occurs when one class (the minority class) has a much smaller number of records compared to the other class (the majority class) in the dataset. In such cases, the machine learning model may be biased towards the majority class and may perform poorly on minority class predictions.

Down sampling involves reducing the number of records in the majority class to match the number of records in the minority class. Hence, the dataset achieves a certain balance, allowing the model to learn both classes more effectively.

Based on the two methods, as expected training the models using the down-sampled dataset produces improved metrics. Hence the resampled dataset will be used for further training. While resampling, the present system sampled 100 k records (majority class) multiple times. The models were trained and cross-validated on each of the multiple samples and the results were almost the same each time. For more details on the results refer to the Cogo Insurance Model building approach and results document.

The present disclosure further describes a bagging-based approach: During the training process, a bagging-based approach is employed, based on the principle of training multiple models on different subsamples of the original dataset. Three distinct subsamples were created from the original dataset, ensuring that all three subsamples retained all the minority class events and varying only based on the majority class events. By employing this strategy, the model's accuracy in predicting the minority class (collision) events is improved, while accounting for variations in the majority class (no collision) events. The reason for creating three subsamples will be explained in the upcoming section.

The model's performance was evaluated on a test set of 2256 samples with 2000 negatives (no collision) and 256 positives (collision). The below table displays the results of various models. Based on evaluating multiple methods, preprocessing for Neural Networks and logistic regression is applied while the resampled dataset can be used directly for training the models in the case of other tree-based and boosting models. The results are arranged in decreasing order of F1 score. Since the dataset is imbalanced it would not be prudent to use accuracy as the evaluation metric. F1-score is the harmonic mean of precision and recall and would be a more reliable metric for imbalanced datasets.

| Model | Accuracy | Precision | Recall | F1-Score |
|---|---|---|---|---|
| LGBM | 0.80 | 0.29 | 0.56 | 0.39 |
| CatBoost | 0.81 | 0.28 | 0.50 | 0.36 |
| Decision Tree | 0.74 | 0.16 | 0.32 | 0.22 |
| Random Forest | 0.90 | 0.84 | 0.18 | 0.29 |
| Neural Network | 0.90 | 0.90 | 0.17 | 0.29 |
| AdaBoost | 0.89 | 0.93 | 0.16 | 0.27 |
| XGBoost | 0.87 | 0.34 | 0.15 | 0.21 |
| Logistic Regression | 0.89 | 0.82 | 0.08 | 0.16 |
| GAM | 0.70 | 0.8 | 0 | 0 |
| Gradient Boosting | 0.5 | 0 | 0 | 0 |

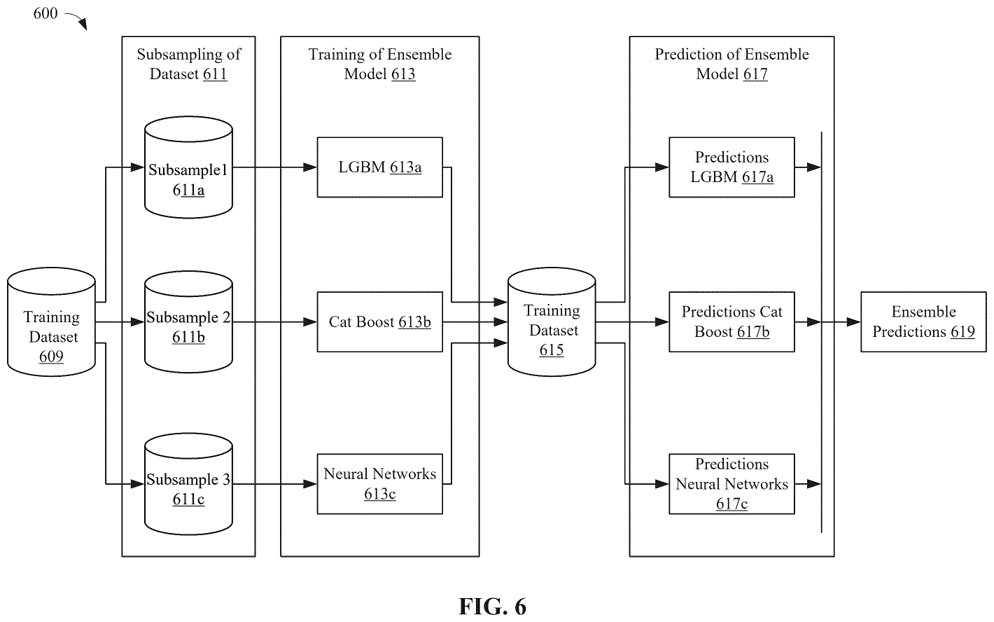

FIG. 6 illustrates a block diagram 600 of using various machine learning models to train an ensemble model, in accordance with one or more example embodiments. Instead of solely depending on a single model, the present insurance system adopts a more robust approach by combining the output from three models: LGBM, CatBoost, and Neural Networks, for making the final predictions. This ensemble technique, known as weighted average ensembling, allows one to leverage the strengths of each individual model, leading to more reliable and accurate predictions for the chances of collision. In various embodiments, a training dataset 609 is received by a subsampling of dataset 611 that includes a first subsample 611a, a second subsample 611b, and a third subsample 611c.

At block 613, the ensemble model is trained based on the received subsample dataset. The ensemble model is trained based on the various models such as LGBM 613a, CatBoost 613b, and Neural Networks 613c. The fundamental concept behind Average Ensemble or Weighted Average Ensemble is to minimize overall errors by combining predictions from diverse classifiers. While training the models, each model will be trained on a different subsample of the original dataset as explained briefly in the previous section. By creating a diverse set of classifiers and consolidating their outputs, the final prediction errors are decreased.

The table below shows the multiple model's predictions in terms of probability (%). LGBM has predicted that there are 78% chance of collision while Neural Networks has predicted a 45% chance of collision. The combined probability is the weighted average of the individual probabilities.

$$Combined Probability = ( 0.4 \times LGBM probability ) + ( 0.3 \times CatBoost probability ) + ( 0.4 \times Neural Networks probability )$$

$$Combined Probability = ( 0.4 \times 78 ) + ( 0.3 \times 65 ) + 0.4 \times 45 ) = 68.7$$

| Probability - | Probability - | Probability - Neural | Combined |
|---|---|---|---|
| LGBM (%) | CatBoost (%) | Networks (%) | Probability |
| 78 | 65 | 45 | 68.7 |

The selection of LGBM, CatBoost, and Neural Networks as models for the present system was based on evaluating multiple models on a testing dataset 615. The testing dataset 615 is then transmitted to a block 617 of a prediction of ensemble model that includes predictions LGBM 617a, predictions CatBoost 617b, and predictions neural networks 617c. At block 619, the ensemble predictions are performed based on the prediction of the ensemble model. It was found that LGBM and CatBoost had higher recall, which is crucial for capturing more positive instances correctly, while Neural Networks demonstrated higher precision, ensuring better accuracy in identifying true positive cases. The below table shows the metrics for the ensembled model. The accuracy and precision improved slightly but recall is in the same range as the LGBM model. Currently, the ensembled models have an accuracy of 82%. There were other machine learning models which were almost 90% accurate. As it was mentioned before since this is an imbalanced dataset, recall is more important, i.e., the model's ability to correctly identify collision events. But ultimately, rather than predicting the collision/near miss event the present system would be predicting the probability of a collision/near miss event.

| Model | Accuracy | Precision | Recall | F1-Score |
|---|---|---|---|---|
| LGBM + CatBoost + | 0.827 | 0.313 | 0.506 | 0.38 |
| Neural Network | | | | |

In an embodiment, the LightGBM (LGBM) is a gradient boosting framework that utilizes tree-based learning algorithms. It is designed to be efficient and fast, making it particularly suitable for large datasets. LGBM uses a histogram-based approach for splitting features, which results in faster training times and improved accuracy.

In an embodiment, the CatBoost is another gradient boosting framework that excels in handling categorical features. Catboost has some in-built mechanisms to prevent overfitting.

In an embodiment, the neural network is a deep learning model consisting of layers of interconnected nodes (neurons) that process and transform data. Neural networks are known for their ability to capture complex patterns in data. They consist of an input layer, one or more hidden layers, and an output layer, with each neuron applying weighted transformations to the input and passing it to the next layer.

Thus, the present insurance system uses the ensemble model to enhance the accuracy and reliability of predictions. Instead of relying on a single model for making predictions, the system employs a more robust strategy. It combines the outputs from three different models: LGBM, CatBoost, and Neural Networks. The ensemble model leverages the strengths of each model to create more dependable predictions regarding the likelihood of a collision. Each model has its unique advantages and can capture different aspects of the data, and by combining their outputs through a weighted average, the system aims to get a more comprehensive and accurate prediction. The training dataset 609 is prepared by subsampling a larger dataset, which is designated as dataset 611. This dataset (611) is divided into three distinct subsamples: the first subsample (611a), the second subsample (611b), and the third subsample (611c). These subsamples are used for training the machine learning models, which form a crucial part of the insurance system. The training process is essential for enabling the models to learn from the data and make accurate predictions. By using various subsamples for training, the insurance system can ensure that the models are exposed to diverse data, enhancing their ability to capture different aspects of the insurance-related information and improve the overall prediction accuracy.

For each day of driving, the present system generates a risk score, in addition to the daily driver score, to estimate the probability of the driver getting into a collision. This risk score considers the driver's behavior on that day and also takes into account their behavior over the preceding two days. This comprehensive analysis enables us to capture both short-term and longer-term driving patterns, providing a more robust assessment of collision risk for each driver.

| | | Features | Daily Driver | |
|---|---|---|---|---|
| DriverID | Date | . . . | Score | Risk Score |
| 123 | 2023 Jul. 14 | . . . | 891 | 34.5 |
| 123 | 2023 Jul. 15 | . . . | 876 | 45.2 |
| 123 | 2023 Jul. 16 | . . . | 883 | 51.3 |

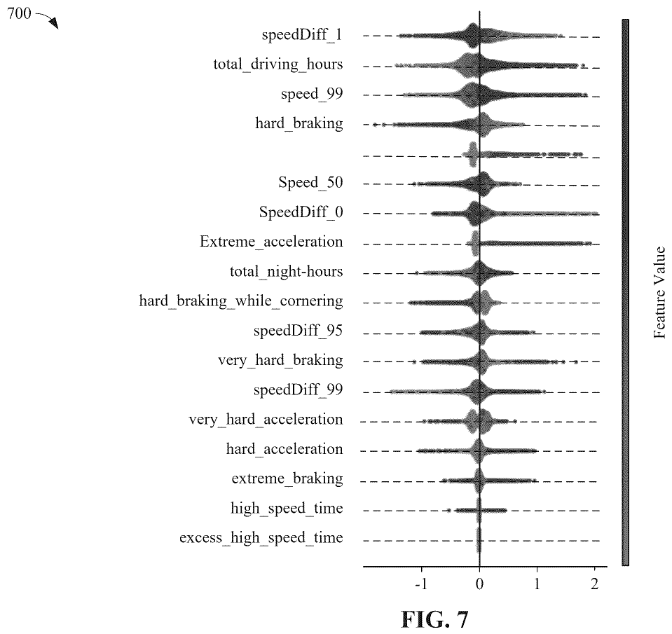

The present insurance system uses SHAP (SHapley Additive explanations) for understanding the model behavior. This is important for transparency and the ability to comply with impending future regulations and laws that will be enacted in the U.S. just like they are being enacted in the EU this year. It is important to be able to show the “black box” of AI/ML and prove to the regulators that there is no chance of discrimination against consumers. FIG. 7 illustrates a graphical representation 700 of a result of the SHAP (SHapley Additive explanations) model built using predictions from the LGBM model, in accordance with one or more example embodiments.

Some of the points evident from the SHAP results are as follows: 1) There is a higher likelihood of a collision when the deceleration values (speedDiff_0 and speedDiff_1) are very low. 2) Increased driving hours are correlated with an elevated risk of collision. 3) The probability of a collision increases as the count of hard, very hard, or extreme accelerations rises. 4) Higher values of very hard braking and extreme braking indicate an increased risk of collision, while higher values of hard braking suggest a lower likelihood of an accident.

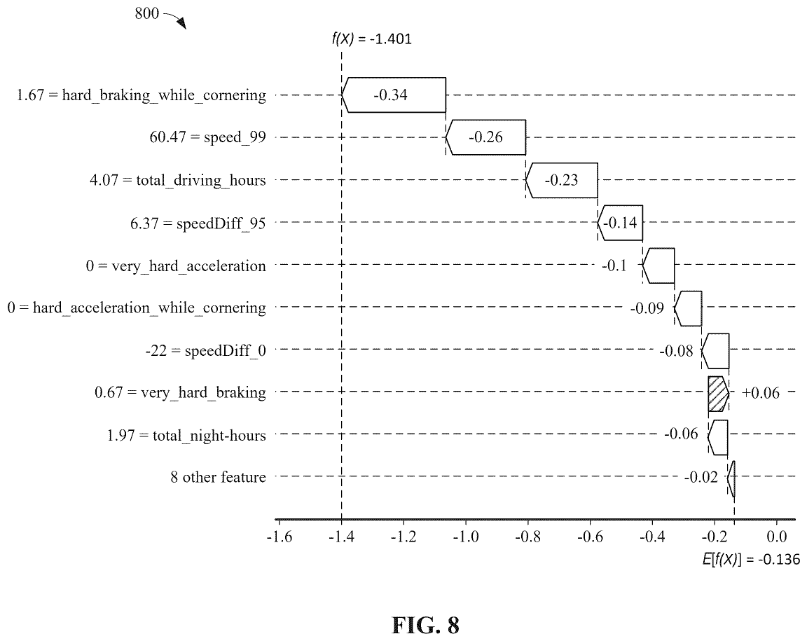

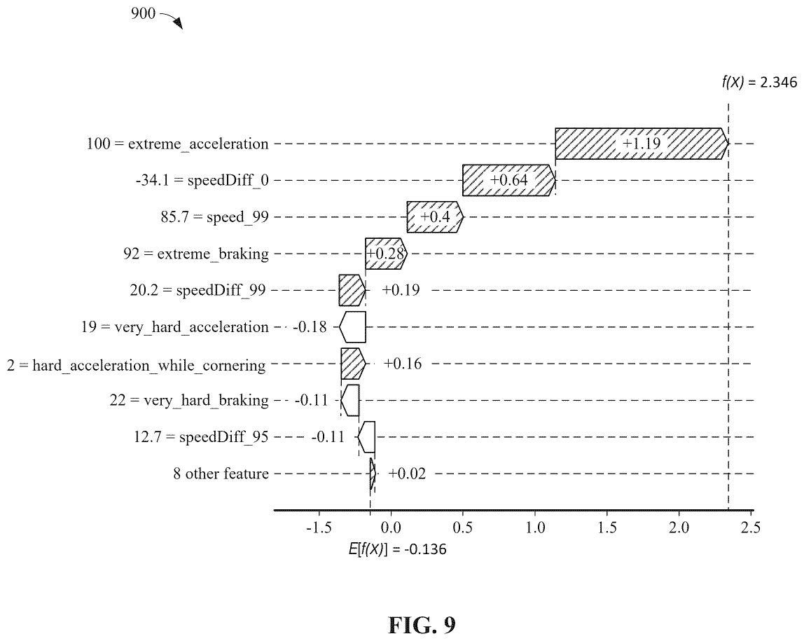

Using Shapley values, the present disclosure gains insights into the rationale behind the model's predictions for each case, understanding why the model has made certain predictions about a driver's likelihood of getting into a collision. These Shapley values allow us to examine the individual contributions of each feature in determining the model's predictions for every record in the dataset. FIG. 8 illustrates a graphical representation 800 of individual feature contributions made by the SHAP model when predicting that a driver would not be involved in a collision, in accordance with one or more example embodiments. FIG. 9 illustrates a graphical representation 900 of individual feature contributions made by the SHAP model when predicting that a driver would be involved in a collision, in accordance with one or more example embodiments. From the FIG. 9, it is evident that the model predicts increased chances of collision due to the higher extreme acceleration and higher deceleration values.

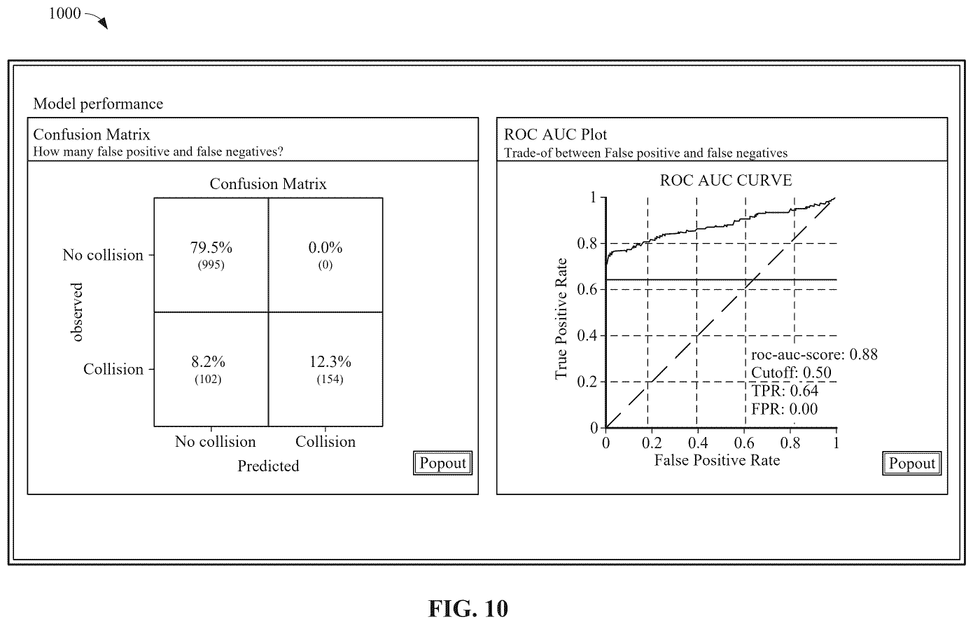

FIG. 10 is a dashboard 1000 of a collision prevention model explainer, in accordance with one or more example embodiments. The dashboard 1000 of the collision prevention model explainer explains the workings of the machine learning model that predicts the probability of a driver getting involved in a collision. The dashboard provides interactive plots on model performance, feature importance, and feature contributions to individual predictions based on SHAP values.

FIG. 10 depicts model performance plots that include a confusion matrix plot and an ROC AUC plot that provide insights into the model performance. The confusion matrix shows the percentage of True Positives, True Negatives, False Positives, and False Negatives. The ROC curve is particularly useful when evaluating the performance of a binary classification model, especially when the class distribution is imbalanced. A perfect classifier has an AUC-ROC of 1, while a random classifier has an AUC-ROC of 0.5. Generally, higher AUC-ROC values indicate better model performance and an AUC-ROC above 0.5 indicates that the model is better than random guessing.

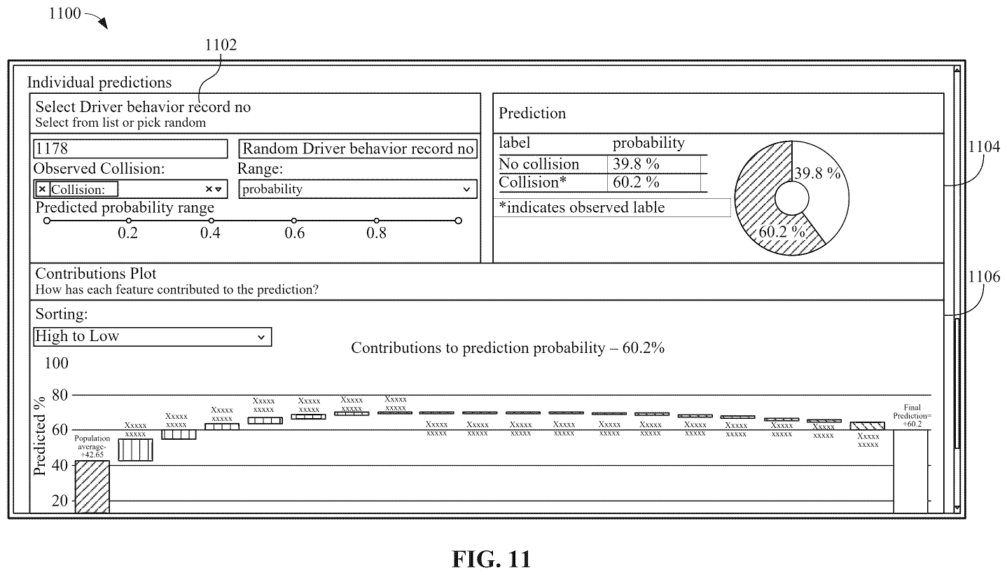

FIG. 11 is a dashboard 1100 of individual features contribution to a specific prediction made by a machine learning model, in accordance with one or more example embodiments. The SHAP individual plot works as follows: 1) selecting a particular driver behavior record number 1102 for which a user wants to interpret the model's prediction. 2) The Prediction plot 1104 displays the probabilities of the selected driver getting involved in a collision and not getting involved in a collision. 3) Lastly, the contributions plot 1106 explains how each feature contributed to the model's prediction compared to a reference value.

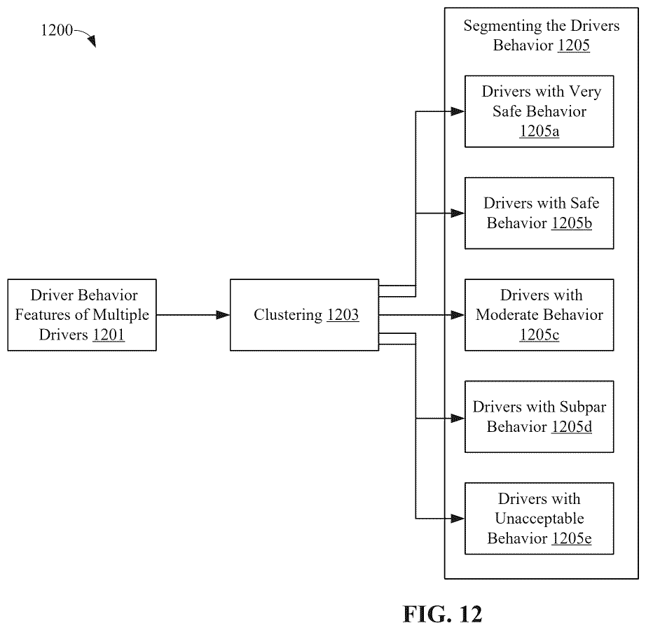

In an embodiment, the present insurance system uses the clustering model to compute the driver behavior to determine the insurance premium amounts. FIG. 12 illustrates a block diagram 1200 of a clustering model, in accordance with one or more example embodiments. Typically, clustering is an unsupervised Machine Learning (ML) model/approach that aims to reveal valuable patterns within extensive datasets. In the present specific case, clustering is utilized to segment drivers according to their behavior. If there were access to data on collisions or accidents caused, the present system could treat this variable as the dependent variable and employ it to determine the likelihood of a specific driver's behavior leading to an accident.

The variables that would act as input to the clustering model includes a number of hard accelerations, number of very hard accelerations, number of extreme accelerations, number of hard braking, number of very hard braking, number of extreme braking, number of hard acceleration while cornering, number of hard braking while cornering, time spent driving above 85 mph, time spent driving above 100 mph, time spent in driving in harsh weather conditions, number of dangerous roads travelled. The present system would use the same set of features as used in the scoring model.

The present disclosure describes the objective of clustering: In the driver scoring model the present system scored a driver for his driving behavior on a particular day. In the clustering approach, a driver's behavior is segmented on a particular day as harsh, safe or moderate, and so on depending upon the number of clusters. The below two tables show the difference between the outcomes in driver score and clustering approaches.

| Driver | | Driver |
|---|---|---|
| ID | Date | Score |
| 123 | 15 Jun. 2023 | 890 |
| 123 | 16 Jun. 2023 | 886 |
| 123 | 17 Jun. 2023 | 872 |

| Driver | | |
|---|---|---|
| ID | Date | Segment |
| 123 | 15 Jun. 2023 | Safe |
| 123 | 16 Jun. 2023 | Safe |
| 123 | 17 Jun. 2023 | Risky |

Currently, the clustering model is trained on about 1 million days of driver activity of around 30,000 drivers observed over multiple months. The present system has used two methods and the first method involves using all the features for segmentation while the second method uses a subset of the features. The clustering model is simply explained in FIG. 12, where it segments drivers into different risk categories based on their driving behaviors. FIG. 12 depicts that the data related to driver behavior features of multiple drivers transmitted from block 1201 to a block 1203 for clustering. Then the clustered data is segmented based on the driver's behavior at block 1205. In an embodiment, an optimal number of clusters to segment the behavior is five, and classified these five clusters as drivers with Very Safe behavior 1205a, drivers with Safe behavior 1205b, drivers with Moderate behavior 1205c, drivers with Subpar behavior 1205d, drivers with Unacceptable behavior 1205e.

The below table represents the average values of some of the features attained by the drivers of the four clusters. The results are displayed for the predictions made on a dataset of 330 k records.

| | Cluster 1 | Cluster 2 | Cluster 3 | Cluster 4 |
|---|---|---|---|---|
| No of records | 98353 | 204095 | 34182 | 180 |
| Average driving | 8 | 6 | 6 | 8 |
| hours | | | | |
| Average speed | 63 | 64 | 58 | 62 |
| Average no of hard | 1 | 1 | 1 | 3 |
| accelerations | | | | |
| Average no of hard | 10 | 8 | 8 | 12 |
| braking's | | | | |
| Average Speed_99 | 73 | 72 | 70 | 74 |

Based on the above table, 180 days of driving activity belong to cluster 4. The average number of driving hours per day is 8 hours. The average speed maintained on those days is 62 mph. The average number of hard accelerations is 3 and the average number of hard brakes is 6. The 4th cluster seems like the group with high variations in driving behavior while the other 3 clusters look almost the same.

The below table represents the average values of some of the above features attained by the drivers of the 5 clusters. The results are displayed for the predictions made on a dataset of 330 k records.

| | Acceleration | Braking | Total driving | No of |
|---|---|---|---|---|
| Category | events | events | hours | days |
| Very Safe | 2 | 10 | 5 | 235k |
| Safe | 4 | 25 | 8 | 79k |
| Moderate | 10 | 42 | 9 | 13k |
| Sub-Par | 24 | 77 | 11 | 7k |
| Un acceptable | 41 | 92 | 12 | 1k |

Based on the above table, on 235 k days the driving activity has been clustered as safe and the average number of driving hours for a driver belonging to this cluster is 5. The average number of acceleration and braking events made by a driver to be classified as safe is very low and it is very high in the case of unacceptable driver behavior clusters.

From the above table, it is evident that the more driving hours, the higher the chances of the increased count of acceleration and braking events. But the major reason for employing the clustering model is to identify two distinct categories of drivers who are: 1. Drivers who have driven for a smaller number of hours but have made a very high number of hard accelerations and brakings. 2. Drivers who have driven for longer durations but have made a considerably lesser number of hard accelerations and brakings.

The present disclosure further describes how the driver score is calculated. Currently, two scores are calculated for a driver daily which are: 1. daily Driver Score (Maximum of 900); 2. Risk Score (Maximum of 100).

There are two ways of using these scores.

In the first method, the two scores are kept separately. I.e., the driver score is not combined with the risk score. In this way, the driver score is used alone for assigning premium to a driver if needed. The risk score is sued to alert a driver to correct his driving behavior. For example, suppose the risk score for a driver is above 90. This indicates that the driver has more chance of getting involved in a collision. In that case, the present system can alert this driver to drive safely.

| DriverID | Driver Score | Risk Score |
|---|---|---|
| 23 | 876 | 24 |
| 41 | 881 | 32 |
| 50 | 840 | 57 |

In the second method, the driver score is combined with the risk score, and this combined score assigns premiums to a driver. But the two scores cannot be combined directly. Currently, higher Driver Scores indicate better driving behavior whereas higher Risk Score indicates rash driving behavior and hence combining them would not be prudent. To resolve this contradiction, the present system calculates something called Safety Score which is the inverse of Risk Score (subtracting Risk Score from one hundred percent: 100−Risk Score). Now higher Safety Scores indicate safe driving behavior and reduced chances of collision.

| | | | Safety Score |
|---|---|---|---|
| DriverID | Driver Score | Risk Score | (100 − Risk Score) |
| 23 | 876 | 24 | 76 |
| 41 | 881 | 32 | 68 |
| 50 | 840 | 57 | 43 |

Once the Driver Score (900) is combined with the Safety Score (100) the overall score would exceed 900. But the objective is to keep the driver's score within 900. In the below table, the last column Combined Driver Score is obtained using the formula:

$$Combined Driver Score = 900 \times [ ( Driver Score + Safety Score ) / 1000 ]$$

| | Driver | Safety | Driver Score + | Combined Driver |
|---|---|---|---|---|
| DriverID | Score | Score | Safety Score (1000) | Score |
| 23 | 876 | 76 | 952 | 856 |
| 41 | 881 | 68 | 949 | 854 |
| 50 | 840 | 43 | 883 | 794 |

In general, the Combined Driver Score would be considerably less than the individual Driver Score.

Another significant aspect of the present disclosure is vehicle scoring, which assesses the condition and performance of vehicles by analyzing data collected through the installed telematics devices. The telematics device installed in the trucks captures data related to the vehicle the condition and engine performance which includes: 1) Fuel level state; 2) Battery voltage state; 3) Engine coolant temperature state; 4) Engine coolant level state; 5) Engine oil temperature state; 6) Engine oil pressure state; 7) Transmission oil temperature state; 8) Cybersecurity; and 9) Tire pressure.

For every feature, there are three states: Normal, High, and Low. Normal state suggests that everything is functioning normally while high or low states may indicate something abnormal, but this is based on the feature.

The present disclosure further describes the battery voltage that represents the electrical potential difference across the vehicle's battery terminals, indicating the level of charge or energy available in the battery.

1. Having a high battery voltage state is generally a positive indication, as it means the battery is in good condition and capable of supplying power to the vehicle's electrical systems.

2. Conversely, a low battery voltage state could suggest that the battery is discharged or experiencing a problem. If the battery voltage state is consistently low, it may require recharging or replacement to ensure proper vehicle operation.

The present disclosure further describes the fuel level state which typically refers to the state or condition of the fuel level in the vehicle's fuel tank. It indicates the status or information related to the fuel level measurement.

1. Normal: This indicates that the fuel level is within the expected range and there are no immediate concerns or issues.

2. Low: This suggests that the fuel level is below a certain threshold considered as a warning level.

The present disclosure further describes the engine coolant temperature state which refers to the state or condition of the engine coolant temperature. The engine coolant temperature represents the temperature of the coolant circulating through the engine's cooling system.

1. Normal: This indicates that the engine coolant temperature is within the expected operating range and there are no immediate concerns or issues.

2. High: This suggests that the engine coolant temperature is higher than the normal operating range. It may indicate that the engine is running hotter than usual, which could be a sign of potential problems such as cooling system issues, insufficient coolant, or a malfunctioning thermostat.

3. Low: Some telematics systems may provide a low coolant temperature warning, indicating that the engine coolant temperature is below the expected range. This could be an indication of a cooling system problem, such as a malfunctioning thermostat or insufficient warm-up time.

The present disclosure further describes the engine coolant level state.

Engine Coolant Level State typically refers to the state or condition of the engine coolant level. The engine coolant level indicates the amount of coolant present in the vehicle's cooling system.

1. Normal: This indicates that the engine coolant level is within the expected range and there are no immediate concerns or issues.

2. Low: This suggests that the engine coolant level is below the recommended level. It indicates that the coolant may need to be topped up to ensure proper cooling system function and prevent overheating.

The present disclosure further describes the engine oil temperature state which typically refers to the state or condition of the engine oil temperature. The engine oil temperature indicates the temperature of the engine oil, which plays a crucial role in lubricating and protecting the engine's internal components.

1. Normal: This indicates that the engine oil temperature is within the expected operating range and there are no immediate concerns or issues.

2. High: This suggests that the engine oil temperature is higher than the normal operating range. The elevated engine oil temperature may be an indication of excessive heat in the engine, potentially caused by factors such as heavy load, aggressive driving, or insufficient engine cooling. Low: In some cases, the Engine Oil Temperature State may indicate a low oil temperature warning. This could occur during cold weather conditions or when the engine has just started, and the oil has not yet reached the optimal operating temperature. It is generally not a cause for immediate concern unless the low oil temperature persists for an extended period.

The present disclosure further describes the engine oil pressure state which typically refers to the state or condition of the engine oil pressure. Engine oil pressure is a crucial parameter that indicates the pressure at which the engine oil is circulated through the engine's lubrication system.

1. Normal: This indicates that the engine oil pressure is within the expected operating range and there are no immediate concerns or issues.

2. Low: This suggests that the engine oil pressure is lower than the normal operating range. Low oil pressure can be a sign of various problems, such as insufficient oil level, oil leaks, oil pump malfunction, or engine component wear. Low oil pressure can result in inadequate lubrication, leading to increased friction and potential engine damage.

3. High: In some cases, the Engine Oil Pressure State may indicate high oil pressure. While high oil pressure is generally better than low oil pressure, excessively high oil pressure can also be a cause for concern.

The present disclosure further describes the transmission oil temperature state which typically refers to the state or condition of the transmission oil temperature. The transmission oil temperature is the temperature of the fluid that is used to lubricate and cool the components of the vehicle's transmission system.

1. Normal: This indicates that the transmission oil temperature is within the expected operating range and there are no immediate concerns or issues. A normal transmission oil temperature helps ensure proper lubrication and cooling of the transmission system.

2. High: If the Transmission Oil Temperature State shows as high, it suggests that the transmission oil temperature is exceeding the normal operating range. High transmission oil temperature can be a sign of various problems, such as excessive load, overheating of the transmission system, low transmission fluid levels, inadequate cooling, or issues with the transmission fluid cooler.

The present disclosure further describes cyber security. This consideration is becoming increasingly important. This feature helps to identify if there are chances for a particular vehicle, especially autonomous, to get affected by a cyber security attack such as hacking into the GPS/ELD system. The U.S. National Vulnerability Database and several private companies keep updating the list of vulnerabilities affecting automotive software systems. Currently, the database does not contain any unpatched vulnerabilities affecting the trucks. But in the future, for example, if there is a vulnerability affecting a Volvo truck, the present system would reduce the cyber security score for the Volvo trucks that the present system is insuring until it is patched. Since protocols for this have not yet been agreed upon by the auto and OEM manufacturers, this feature will go through many changes in the future.

The present disclosure further describes vehicle score calculation. Based on the above set of features the scores for vehicles will be calculated. However, each truck installs a different kind of device that transmits vehicle conditions at different intervals. For example, truck A would be recording data at 5-second intervals while truck B would be recording data at 1-hour intervals. The objective is to find the overall state of a feature or the state in which a vehicle was driven throughout the day i.e it needs to identified if a vehicle was driven at low battery voltage states on a particular day. The below table shows the summary of the normal and low battery voltage states recorded in different vehicles on a particular day:

| | | Number of | Low Battery | Normal Battery |
|---|---|---|---|---|
| Vehicle ID | Date | records | voltage state | voltage state |
| 1235 | 2023 Jan. 12 | 23 | 3 | 20 |
| 2451 | 2023 Jan. 12 | 69 | 9 | 60 |
| 5679 | 2023 Jan. 12 | 18 | 15 | 3 |
| 3968 | 2023 Jan. 12 | 189 | 168 | 21 |
| 789 | 2023 Jan. 12 | 5 | 0 | 5 |
| 1904 | 2023 Jan. 12 | 32 | 31 | 1 |

Based on the above table the final states for each vehicle are expected to achieve on each day would be:

| | | | Low | Normal | Final |
|---|---|---|---|---|---|
| | | | Battery | Battery | Battery |
| Vehicle | | Number of | Voltage | Voltage | Voltage |
| ID | Date | records | state | state | state |
| 1235 | 2023 Jan. 12 | 23 | 3 | 20 | normal |
| 2451 | 2023 Jan. 12 | 69 | 9 | 60 | normal |
| 5679 | 2023 Jan. 12 | 18 | 15 | 3 | low |
| 3968 | 2023 Jan. 12 | 189 | 168 | 21 | low |
| 789 | 2023 Jan. 12 | 5 | 0 | 5 | normal |
| 1904 | 2023 Jan. 12 | 32 | 31 | 1 | low |

The present system would be finding the ratio of the Low battery voltage state to the Normal battery voltage state on each day for a vehicle. If a low battery voltage state was prevalent on most of the day, then the ratio would be higher. If the ratio is greater than 0.5 then it is ascertained that the battery voltage state or any other feature was low or high on that particular day.

| | | | Low | Normal | | Final |
|---|---|---|---|---|---|---|
| | | | Battery | Battery | | Battery |
| Vehicle | | Number of | Voltage | Voltage | | Voltage |
| ID | Date | records | state | state | Ratio | state |
| 1235 | 2023 1 Dec. | 23 | 3 | 20 | 0.15 | normal |
| 2451 | 2023 1 Dec. | 69 | 9 | 60 | 0.15 | normal |
| 5679 | 2023 1 Dec. | 18 | 15 | 3 | 5 | low |
| 3968 | 2023 1 Dec. | 189 | 168 | 21 | 8 | low |
| 789 | 2023 1 Dec. | 5 | 0 | 5 | 0 | normal |
| 1904 | 2023 1 Dec. | 32 | 31 | 1 | 31 | low |

Hence for a particular day for a particular vehicle, the present system finds out the final state for each feature. The present system can assign a weightage for each of the above features and arrive at the vehicle score for a vehicle. A vehicle can be assigned a maximum score of 100 per day.

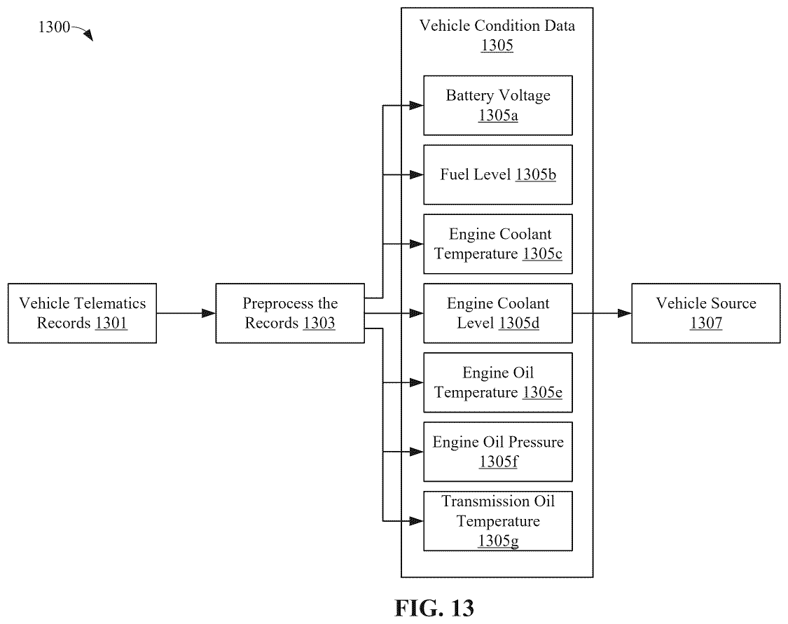

FIG. 13 illustrates a block diagram 1300 of a vehicle score model, in accordance with one or more example embodiments. The block diagram 1300 depicts that the vehicle telematics records 1301 preprocessed at block 1303. Then, at block 1305, the vehicle condition data is obtained. In an embodiment, the vehicle condition data includes battery voltage 1305a, fuel level 1305b, engine coolant temperature 1305c, engine coolant level 1305d, engine oil temperature 1305e, engine oil pressure 1305f, and transmission oil temperature 1305g. Based on the vehicle condition data, vehicle score 1307 is computed to provide vehicle maintenance recommendations to trucks to avoid vehicle failure or breakdown. The objective is to identify and address critical engine-related conditions such as low engine coolant levels, high engine oil temperature, and other such conditions. The present system has existing information about whether various engine conditions, including fuel level state and battery voltage state, were normal or abnormal on a specific day. By considering these multiple engine-related features and their severity, the goal is to determine whether a truck requires maintenance or not. To achieve this outcome, an unsupervised learning algorithm called isolation forest is utilized. This algorithm can effectively identify anomalies in the data, helping us detect and prioritize potential maintenance needs for trucks based on the severity of engine-related conditions.

Typically, Anomalies are data points that deviate significantly from the rest of the data points in the dataset. Isolation forest is an anomaly detection Machine Learning (ML) algorithm that helps to identify these anomaly points without the need for any labels or target variables.

Anomaly detection helps in predicting vehicle maintenance. To achieve this objective, the present system has collected vehicle behavior data from thousands of trucks over 4 months. It is observed that around 70% of the time, all the vehicle features, including fuel level state, battery voltage state, and engine oil temperature are within normal ranges. The below table illustrates the observed behavior of three different trucks. In the first case, everything is normal, while in the second case, only the fuel level state is low, which is not a significant concern. However, in the third case, numerous critical engine conditions, such as abnormal battery voltage state and engine coolant level, are detected. This behavior pattern stands out as an anomaly, deviating significantly from the majority of the vehicle's behavior.

| | | | | Engine | Engine | Engine | Engine | Transmission | | |
|---|---|---|---|---|---|---|---|---|---|---|
| Vehicle | | Fuel | Battery | coolant | coolant | oil | oil | oil | Cyber | Tire |
| ID | Date | level | voltage | temp | level | temp | pressure | temp | security | pressure |
| 123 | 14 Jun. 2023 | normal | normal | normal | normal | normal | normal | normal | normal | normal |
| 245 | 14 Jun. 2023 | low | normal | normal | normal | normal | normal | normal | normal | normal |
| 326 | 15 Jun. 2023 | normal | low | normal | low | high | high | normal | normal | normal |

The present disclosure further describes training and evaluation. The isolation forest classifiers were trained using a dataset of over 600 k records, encompassing multiple trucks and spanning 4 months. The isolation forest algorithm operates on the principle that anomalies are rare and distinct observations, making them easier to identify in contrast to normal data points. By employing an ensemble of isolation trees, the algorithm efficiently isolates and pinpoints these unusual data points within the dataset. After training the isolation forest model, the present system tested it on 40 k records of vehicle behavior. Among these 40 k records, 29 k records exhibited normal vehicle-related conditions. For anomaly detection, the isolation forest returns −1 in case of an anomaly and 1 for normal data points. The provided table shows the vehicle behavior records for two trucks. In the first case, all engine-related conditions were normal, and the model correctly returned 1, indicating it was not an anomaly. In the second case, where the battery voltage state, engine coolant level, and engine oil temperature features were abnormal, the model accurately returned −1, correctly recognizing it as an anomaly. This demonstrates the effectiveness of the isolation forest algorithm in identifying anomalous behavior and distinguishing it from normal patterns in vehicle behavior data.

| | | Engine | Engine | Engine | Engine | Transmission | |
|---|---|---|---|---|---|---|---|
| Fuel | Battery | coolant | coolant | oil | oil | oil | |
| level | voltage | temp | level | temp | pressure | temp | Anomaly |
| normal | normal | normal | normal | normal | normal | normal | 1 |
| normal | low | normal | low | high | low | normal | −1 |

While evaluating the performance of these models various metrics were not used such as accuracy or recall. Instead, the present system focuses on determining whether the model accurately identifies vehicles with abnormal behavior as anomalies. To achieve this, the present system selects records from the testing set that exhibited low engine coolant levels, high engine oil temperatures, or high engine coolant temperatures. Subsequently, it is examined whether these models correctly detected these records as anomalies or not. The results are shown in the table below.

| | No of abnormal | Anomalies detected |
|---|---|---|
| Feature | records | by the model |
| Low Engine Coolant Level | 332 | 332 |
| High Engine Oil Temperature | 180 | 180 |
| High Engine Coolant Temperature | 12 | 7 |

There was a total of 332 records with low engine coolant levels and the isolation forest detected them all as anomalies. Only in the case of high engine coolant temperature were there a total of 12 records and the model missed out on 5 records.

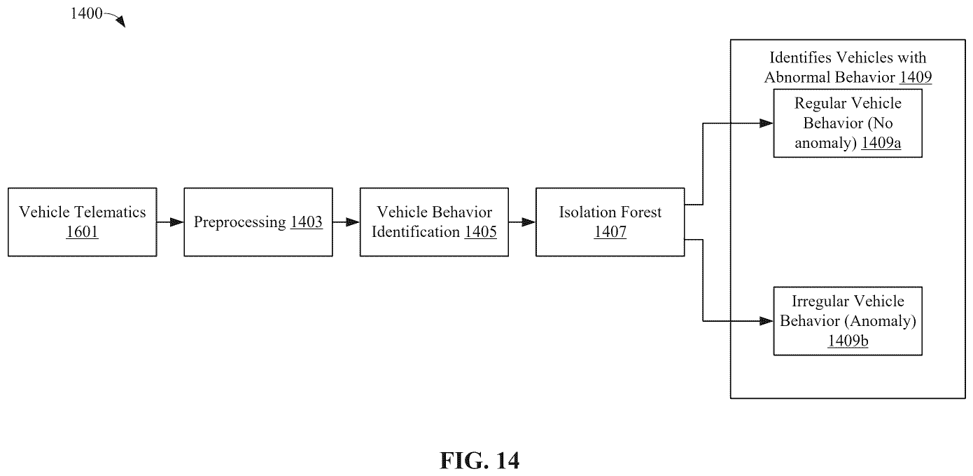

FIG. 14 is a flowchart 1400 of an anomaly detection process, in accordance with one or more example embodiments. The anomaly detection process initiates with a step 1401 of receiving vehicle telematics records. At step 1403, the vehicle telematics records are preprocessed. At step 1405, vehicle behavior is identified based on the preprocessed vehicle telematics records. Then at step 1407, isolation forest is applied to identify vehicles with abnormal behavior at block 1409. The isolation forest categorizes the regular vehicle behavior (no anomaly) at block 1409a. The isolation forest categorizes the irregular vehicle behavior (anomaly) at block 1409b.

A fleet in general operates with more than 1 truck driver. For example, there is a fleet called ABC with 5 drivers for whom ELD data is collected. The fleet score could be the sum of the average of the driver scores of these 5 drivers and the average of the vehicle scores of the vehicles used by them. For example, the previous case of fleet ABC is considered, which had five drivers. The table below displays the average driver scores, calculated based on the number of days each driver has been on duty.

| Driver ID | Total number of days driven | Average driver score |
|---|---|---|
| 123 | 8 | 878 |
| 245 | 21 | 865 |
| 321 | 7 | 886 |
| 221 | 16 | 890 |
| 278 | 10 | 850 |

| | |
|---|---|
| Average score of 5 drivers | 873.8 |

The fleet operates with 3 vehicles are considered.

| Vehicle ID | Total number of days driven | Average vehicle score |
|---|---|---|
| 12 | 22 | 97 |
| 24 | 15 | 87 |
| 32 | 19 | 84 |

| | |
|---|---|
| Average score of 3 vehicles | 89.3 |

Hence the overall fleet score can be the sum of the average driver score and average vehicle score which will be 963.1. The maximum score for a fleet would be 1000.

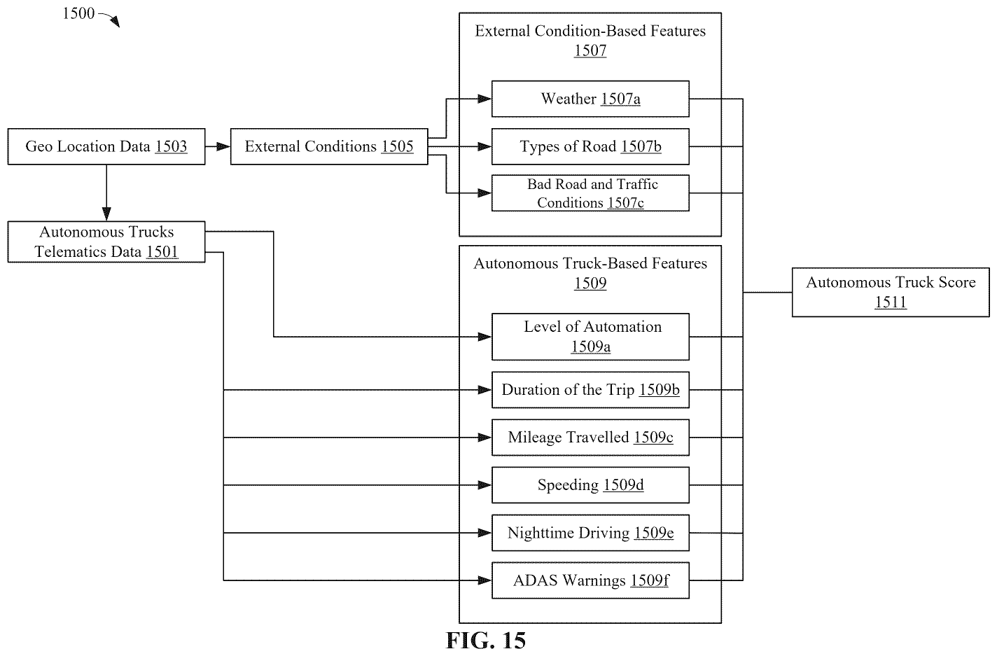

FIG. 15 is a flowchart 1500 of a process to compute an Autonomous Truck (AT) score, in accordance with one or more example embodiments. The process of computing the AT score initiates with a step 1501 of collecting AT telematics data from the ELD device. Then at block 1509, autonomous truck-based features are identified from the AT telematics data. The autonomous truck-based features include but are not limited to the level of automation 1509a, duration of the trip 1509b, mileage travelled 1509c, speeding 1509d, nighttime driving 1509e, and ADAS warnings 1509f.

Further, at block 1503, geolocation data is obtained from the AT telematics data. Then at block 1505, external conditions are identified based on the geolocation data. At block 1507, external conditions are obtained from the geolocation data. Examples of the external conditions include but are not limited to weather 1507a, types of road 1507b, and bad road and traffic conditions 1507c. Lastly, at block 1511, an AT score is computed based on the external conditions and the autonomous truck-based features.

In another embodiment, the present insurance system provides a comprehensive assessment of autonomous trucks' behavior by factoring in the various risks associated with these trucks. To understand the risks posed to autonomous trucks, the autonomous truck crash dataset was made available by the U.S. National Highway Traffic Safety Administration (NHTSA). It's the only such comprehensive dataset available. In June 2021, the NHTSA issued a General Order mandating manufacturers and operators of vehicles equipped with ADS or ADAS to report all crashes involving these systems on public roads in the United States. This order covers Level 1, 2 ADAS, and Levels 3 to 5 ADS vehicles. The dataset contains information regarding autonomous trucks involved in the incident, the environmental conditions at the time of the incident, fatalities or injuries reported, etc.

With the help of the NHTSA dataset and other information available with respect to self-driving trucks the present system analyzes different factors that serve as challenges to the operations of autonomous trucks.

The present system has classified the factors into two distinct classes: 1) Autonomous truck-based features: These include features related to the autonomous trucks and the features derived from the telematics data obtained from these trucks such as level of automation, duration of the trip, mileage travelled, speeding, nighttime driving, ADAS warnings, and vehicle conditions. 2) External conditions-based features: These include features related to the environment and the conditions in which the truck is operating such as weather, road type, road surface conditions, and traffic conditions.

Based on these multiple factors the present system will be deriving a score called Autonomous Truck Score (AT Score) that provides a good representation of the risks associated with the autonomous truck as well as external factors that serve as dangers to these trucks. The present system will be calculating the AT Score for each trip traveled by autonomous truck. This AT Score will serve as the basis for fixing insurance premiums for autonomous trucks. The various features are explained in detail below with examples of how weightages and penalties will be computed for the same.

The present disclosure further describes the specific autonomous truck-based features in detail.

1) Level of Automation: There are two distinct categories within driving automation: Advanced Driver Assistance Systems (ADAS) and Automated Driving Systems (ADS). ADAS encompasses level 1 and level 2 systems, which assist the driver but do not take full control of the vehicle. These systems offer features like automatic emergency braking and adaptive cruise control. On the other hand, ADS, ranging from level 3 to level 5, represents trucks that are still in the testing phase but have the potential to operate with reduced or no manual intervention.

The NHTSA dataset revealed that ADS trucks have no fatalities reported in any of the 362 incidents they were involved in, and there have been no injuries in 272 of those cases. On the other hand, ADAS vehicles have been involved in 19 fatalities. However, drawing conclusions based on this data alone can be misleading, as ADS systems are still under trial, possibly in areas with limited human activity. While inspecting the properties damaged or collisions with other vehicles, it is observed that both ADS and ADAS trucks have primarily been involved in incidents with passenger cars or SUVs. However, ADAS trucks have been involved in approximately 120 collisions with fixed objects, while ADS trucks have been in only 8 such cases.

The present system needs to know the level of ADAS being utilized in autonomous trucks. Currently, it is assumed that trucks with manual intervention (levels 1, 2, 3) are relatively safer compared to completely autonomous trucks (levels 4, 5), which are still in the testing phase. Hence, the present system assigns more penalty points for completely autonomous trucks compared to those trucks that have a human presence. As the autonomous truck industry evolves, the present system will have more data on safety and risk associated with different levels of ADAS system and the scoring system can be altered accordingly.

| Level of ADAS | Weightage |
|---|---|
| Levels 1, 2, 3 | 10 |
| Levels 4, 5 | 20 |

2) Duration of the trip: This feature represents the total time a truck spent travelling during a trip. As the duration of the trip increases, the possibility of encountering various driving conditions increases, which in turn increases the potential chances of accidents or collisions. The present system assigns only one penalty point for every hour spent during the trip.

| Total duration of | Penalty (Total |
|---|---|
| the trip (hours) | duration × 1) |
| 4.5 | 4.5 |
| 7.9 | 7.9 |

3) Mileage traveled: Mileage traversed or total miles driven by the autonomous truck has an impact on the accidents. From the NHTSA crashes dataset, it is evident that trucks with comparatively higher mileage covered have increased chances of causing injuries and fatalities. The more miles the truck has driven the chances of an accident increase. Hence, the present system can deduct points from the AT Score in proportion to the miles driven. The penalties assigned to different mileage categories are as follows:

| Mileage category | Penalty |
|---|---|
| Less than 10000 miles | 1 |
| 10000-20000 miles | 2 |
| 20000-30000 miles | 3 |
| 30000-40000 miles | 4 |
| More than 40000 miles | 5 |

For example, an autonomous truck with a mileage of 23000 miles before the trip is taken. Based on the above table 3 points will be deducted from the AV Sore. Currently, the present system has assigned only minimal penalty points for miles driven before the trip since there are not enough information to conclude that there is a significant correlation between mileage and accidents.

4) Speeding: Over speeding is one of the leading contributors to accidents. In the USA most roads have a posted speed limit of around 75 mph while some roads have a posted speed limit of 85 mph. From the crash dataset, it is evident that an average speed above 50 mph increases the probability of injuries. To assess speeding behavior, the AT Score will consider the following factors:

Average Speed: The average speed at which the truck was operated throughout the day.

Maximum Speed: The highest speed attained by the truck during the trip.

Time Spent Above 75 mph: The total time spent by the truck traveling above the speed limit of 75 mph. For every 1 minute spent driving above 75 mph, 1 penalty point will be assigned.

The below table provides an example of how penalties get calculated.

| | | | Penalty (Measure × |
|---|---|---|---|
| | Measure | Weightage | Weightage) |
| Median speed (mph) | 43 | 0.1 | 4.3 |
| Maximum speed (mph) | 68 | 0.1 | 6.8 |

| Time spent above | Duration of the | Percentage of time |
|---|---|---|
| 75 mph (minutes) | trip (minutes) | spent over speeding |
| 23 | 360 | 6.3 |

Hence the total speeding penalty will be the total of all three components.

| | |
|---|---|
| Median speed penalty | 4.3 |
| Maximum speed penalty | 6.8 |
| Percentage of time spent over speeding | 6.3 |
| Speeding penalty | 17.4 |

5) Nighttime driving: Nighttime driving poses significant risks, and it has been identified as one of the major contributing factors to accidents. According to the Traffic Safety Facts 2020 Data analysis by the National Highway Traffic Safety Administration, 77% of pedestrian fatalities occurred during nighttime hours. The major reason for increased danger during nighttime driving is the dark lighting conditions, which can reduce visibility and increase the chances of accidents.

Nighttime driving becomes an even bigger cause of concern for autonomous trucks. A research report published by the Insurance Institute for Highway Safety in 2022 highlights that while automatic emergency braking (AEB) systems are effective at detecting pedestrians during the daytime, they may not perform well at night, especially on roads without proper street lighting.

To account for the risks associated with nighttime driving, the present system incorporates the total number of hours spent traveling during the night into the AT Score calculation. Currently, the present system considers night hours to be from 8:00 pm to early morning at 5:00 am. The present system assigns 1 penalty point for every hour spent at night. The below table shows an example of how penalties get calculated.

| Nighttime | Penalty (Nighttime |
|---|---|
| hours | hours × 1) |
| 4.3 | 4.3 |

6) ADAS warnings: Advanced Driver Assistance Systems (ADAS) generate different types of warnings and alerts to help drivers avoid accidents or collisions. These warnings are also generated during risky situations. Some of the common types of ADAS warnings supported by all vehicle makers are:

Forward Collision Warning (FCW): The ADAS system monitors the distance between the truck and the vehicle ahead. If the system detects that the distance is too short, it will issue a warning to alert the driver to apply the brakes.

Rear Collision Warning (RCW): This feature is designed to provide warnings when there is a risk of a collision with a vehicle approaching from behind.

Lane Departure Warning (LDW): This alert is issued when the vehicle starts moving out of the lane without using proper signals.

Blind Spot Monitoring (BSM): When another vehicle is detected in the blind spot area of the truck, the ADAS system will activate a warning.

Rear Cross Traffic Alert (RCTA): RCTA systems are typically active when the vehicle is in reverse. They use sensors to detect approaching vehicles or pedestrians.

Speed Limit Alert: ADAS systems use GPS and map data to detect the speed limit on the road. If the truck exceeds the speed limit, the system issues a warning.

Automatic Emergency Braking: This feature helps the truck to automatically apply brakes when an obstruction or vehicle is detected.

Monitoring each of these alerts becomes very important. A higher number of occurrences of these alerts during a trip indicates that the truck had more chances of getting into a collision or that the truck had traveled through highly congested and challenging road conditions.

The present system can get the number of occurrences of these alerts from the telematics data of the autonomous trucks. Using this feature, the present system will be keeping track of the number of such alerts made during the entire duration of the trip. Different alerts weigh differently with more severe and less common alerts given more weightage in the AT Score. An autonomous truck has driven for 6 hours is considered for this example and the table below represents the various warnings generated during the trip.

| Type of warning | Frequency | Frequency per trip |
|---|---|---|
| Forward Collision Warning | 3 | 3/6 = 0.5 |
| Rear Collision Warning | 7 | 7/6 = 1.16 |
| Lane Departure Warning | 10 | 10/6 = 1.6 |
| Blind Spot Monitoring | 5 | 5/6 = 0.83 |
| Speed Limit Alert | 3 | 3/6 = 0.5 |
| Automatic Emergency | 1 | 1/6 = 0.16 |
| Braking | | |

| | | | Penalty |
|---|---|---|---|
| | | | (Frequency |
| | Frequency | | per trip × |
| Type of warning | per trip | Weightage | Weightage) |
| Forward Collision Warning | 0.5 | 10 | 5 |
| Rear Collision Warning | 1.16 | 10 | 11.6 |
| Lane Departure Warning | 1.6 | 5 | 8 |
| Blind Spot Monitoring | 0.83 | 5 | 4.15 |
| Speed Limit Alert | 0.5 | 10 | 5 |
| Automatic Emergency Braking | 0.16 | 20 | 3.2 |

| | |
|---|---|
| ADAS Warnings penalty | 36.95 |

7) Vehicle conditions: Another important aspect is assessing the engine-related conditions and performance of autonomous trucks by analyzing the telematics data collected from the trucks. It is assumed that the autonomous trucks would capture data related to the vehicle conditions and engine performance which includes but is not limited to: 1. Fuel level state; 2. Battery voltage state; 3. Engine coolant temperature state; 4. Engine coolant level state; 5. Engine oil temperature state; 6. Engine oil pressure state; 7. Transmission oil temperature state; 8. Tire pressure; 9. Cybersecurity.

Every feature has three different states: Normal, High, and Low. Normal state suggests that everything is functioning normally while high or low states may indicate something abnormal, but this is based on the feature.

Battery voltage state: The battery voltage represents the electrical potential difference across the vehicle's battery terminals, indicating the level of charge or energy available in the battery.

1. Having a high battery voltage state is generally a positive indication, as it means the battery is in good condition and capable of supplying power to the vehicle's electrical systems.

2. Conversely, a low battery voltage state could suggest that the battery is discharged or experiencing a problem. If the battery voltage state is consistently low, it may require recharging or replacement to ensure proper vehicle operation.

Fuel Level State: Fuel Level State typically refers to the state or condition of the fuel level in the vehicle's fuel tank. It indicates the status or information related to the fuel level measurement.

1. Normal: This indicates that the fuel level is within the expected range and there are no immediate concerns or issues.

2. Low: This suggests that the fuel level is below a certain threshold considered as a warning level.

Engine Coolant Temperature state: Engine Coolant Temperature State typically refers to the state or condition of the engine coolant temperature. The engine coolant temperature represents the temperature of the coolant circulating through the engine's cooling system.

1. Normal: This indicates that the engine coolant temperature is within the expected operating range and there are no immediate concerns or issues.

2. High: This suggests that the engine coolant temperature is higher than the normal operating range. It may indicate that the engine is running hotter than usual, which could be a sign of potential problems such as cooling system issues, insufficient coolant, or a malfunctioning thermostat.

3. Low: Some telematics systems may provide a low coolant temperature warning, indicating that the engine coolant temperature is below the expected range. This could be an indication of a cooling system problem, such as a malfunctioning thermostat or insufficient warm-up time.

Engine Coolant Level State: Engine Coolant Level State typically refers to the state or condition of the engine coolant level. The engine coolant level indicates the amount of coolant present in the vehicle's cooling system.

1. Normal: This indicates that the engine coolant level is within the expected range and there are no immediate concerns or issues.

2. Low: This suggests that the engine coolant level is below the recommended level. It indicates that the coolant may need to be topped up to ensure proper cooling system function and prevent overheating.

Engine Oil Temperature State: Engine Oil Temperature State typically refers to the state or condition of the engine oil temperature. The engine oil temperature indicates the temperature of the engine oil, which plays a crucial role in lubricating and protecting the engine's internal components.

1. Normal: This indicates that the engine oil temperature is within the expected operating range and there are no immediate concerns or issues.

2. High: This suggests that the engine oil temperature is higher than the normal operating range. The elevated engine oil temperature may be an indication of excessive heat in the engine, potentially caused by factors such as heavy load, aggressive driving, or insufficient engine cooling.

3. Low: In some cases, the Engine Oil Temperature State may indicate a low oil temperature warning. This could occur during cold weather conditions or when the engine has just started, and the oil has not yet reached the optimal operating temperature. It is generally not a cause for immediate concern unless the low oil temperature persists for an extended period.

Engine Oil Pressure State: Engine Oil Pressure State typically refers to the state or condition of the engine oil pressure. Engine oil pressure is a crucial parameter that indicates the pressure at which the engine oil is circulated through the engine's lubrication system.

1. Normal: This indicates that the engine oil pressure is within the expected operating range and there are no immediate concerns or issues.

2. Low: This suggests that the engine oil pressure is lower than the normal operating range. Low oil pressure can be a sign of various problems, such as insufficient oil level, oil leaks, oil pump malfunction, or engine component wear. Low oil pressure can result in inadequate lubrication, leading to increased friction and potential engine damage.

3. High: In some cases, the Engine Oil Pressure State may indicate high oil pressure. While high oil pressure is generally better than low oil pressure, excessively high oil pressure can also be a cause for concern.

Transmission Oil Temperature State: Transmission Oil Temperature State typically refers to the state or condition of the transmission oil temperature. The transmission oil temperature is the temperature of the fluid that is used to lubricate and cool the components of the vehicle's transmission system.

1. Normal: This indicates that the transmission oil temperature is within the expected operating range and there are no immediate concerns or issues. A normal transmission oil temperature helps ensure proper lubrication and cooling of the transmission system.

2. High: If the Transmission Oil Temperature State shows as high, it suggests that the transmission oil temperature is exceeding the normal operating range. High transmission oil temperature can be a sign of various problems, such as excessive load, overheating of the transmission system, low transmission fluid levels, inadequate cooling, or issues with the transmission fluid cooler.

Tire Pressure: Tire pressure is a critical factor in the operation of any vehicle, including autonomous trucks. Maintaining adequate tire pressure is important for the efficient performance of trucks.

1. Normal: When tires are properly inflated and maintain the manufacturer-recommended pressure, they are considered to be in the normal state. Normal tire pressure is essential for optimal performance, safety, and efficiency of autonomous trucks. The risk of blowouts and sudden tire failures is significantly reduced, enhancing overall road safety.

2. High: High tire pressure occurs when the air pressure within the tires exceeds the recommended levels. While less common than low tire pressure, overinflated tires have reduced contact with the road, potentially affecting traction, braking, and stability.

3. Low: Low tire pressure, where the air pressure is below the recommended levels, is a critical state that requires immediate attention. Reduced tire pressure can decrease fuel efficiency and increase operating costs. Operating trucks with low tire pressure over a long period can lead to tire blowouts in the future.

Cyber Security: This feature is designed for the future. This feature helps to identify if there are chances for a particular vehicle to get affected by a cyber security attack such as hacking into the GPS. The National Vulnerability Database of the USA keeps updating the list of vulnerabilities affecting a software system. But currently, the database does not contain any vulnerabilities affecting the trucks. But in the future, for example, if there is a vulnerability affecting a Volvo truck, the cyber security score would be reduced for the Volvo trucks that the present system is insuring.

Hence for a particular day for a particular truck, the present system would be able to find out the state for each feature:

| | | | | | | Engine | | | |
|---|---|---|---|---|---|---|---|---|---|
| | Fuel | Battery | | Coolant | Engine | Oil | Transmission | | |
| Autonomous | Level | Voltage | Coolant | Level | Oil | Pressure | Oil Temp | Cyber- | Tire |
| truck | State | State | TempState | State | TempState | State | State | security | Pressure |
| A | normal | low | normal | low | high | normal | normal | normal | low |
| B | normal | normal | high | normal | normal | normal | high | normal | normal |
| C | normal | low | normal | low | normal | normal | normal | normal | low |

The present system can assign a weightage for each of the above features and arrive at the vehicle score for a vehicle. A vehicle can be assigned a maximum score of 50 per day. The flowchart below provides a good overview of the vehicle score model.

### External Conditions-Based Features:

1) Weather: Bad weather conditions pose a significant risk to road safety compared to clear weather conditions. The risks get amplified in the case of autonomous trucks. ADAS systems use multiple sensors to enable safe driving. However, these sensors lose their ability to function properly under bad weather conditions. During heavy rain, snowfall, or fog the camera sensors might have difficulty in seeing the roads clearly, which can impact the ADAS's ability to make the right decisions. Such situations require the intervention of humans to handle the driving. This is also one of the reasons why more points from the AT Score are deducted for trucks operating without drivers. Under this feature, the present system will be calculating the total time spent by trucks under harsh weather conditions.

To achieve this outcome, the present system requires the help of 3rd party weather APIs that provide weather information at a place based on geolocation and time of travel. The present system will be able to get the geolocation from the GPS data of the autonomous trucks and feed it to these 3rd party APIs the present system will be able to know whether the autonomous truck was traveling under bad weather conditions. The present system will be calculating the penalty as the percentage of time spent in bad weather conditions during the trip.

| Time spent in | Total | | | |
|---|---|---|---|---|
| harsh weather | duration | % of time spent | | Harsh weather |
| conditions | of the | in harsh weather | | conditions |
| (hours) | trip | conditions | Weightage | penalty |
| 1.2 | 6.8 | 1.2/6.8 = 17.6 | 2 | 35.2 |
| 0.8 | 9.1 | 0.8/9.1 = 8.7 | 2 | 17.4 |

2) Road type: Different types of roads, such as Interstate highways, State highways, and major and minor collector roads, present unique challenges to the Advanced Driver Assistance Systems (ADAS) in autonomous trucks. Among these, intersections are particularly challenging for autonomous vehicles due to the convergence of multiple vehicles and pedestrians from different directions. In the NHTSA dataset around 90% of the incidents reported by ADS have occurred in intersections and streets where vehicle and pedestrian movement is comparatively higher. In the case of ADAS, a significant chunk of accidents has occurred on highways followed by intersections and streets. Hence considering the roads traversed by autonomous trucks and the traffic conditions encountered becomes important in the AT Score calculation.

Utilizing the FMCSA crashes dataset from 2020 to 2022 and cross-referencing additional open-source data the present system has compiled a list of dangerous sections of highways, dangerous intersections, and other dangerous roads with the highest crash occurrences. The present system can leverage a 3rd party reverse geocoding API to retrieve road names based on geolocations from the telematics data obtained from the autonomous trucks. By comparing these road names with the list of dangerous roads, the present system can determine if the truck traveled through such dangerous roads or sections. The below table shows examples of penalties assigned in the case of dangerous roads encountered. The present system assigns 2 penalty points for every dangerous road encountered.

| No of dangerous | | Penalty (No of |
|---|---|---|
| roads/intersections | | dangerous roads |
| encountered | Weightage | vs. Weightage) |
| 3 | 2 | 6 |
| 5 | 2 | 10 |

3) Road surface conditions: This feature helps us to know whether the autonomous truck was traveling through States with poor road surface conditions. ADAS relies on features like Automatic Emergency Braking to apply brakes promptly. However poorly maintained roads with potholes or uneven patches might affect the ADAS system's ability to make the right decisions. Lane Departure Warning (LDW) systems depend on clear lane markings for accurate operation. Poorly maintained road surfaces with unclear lane markings might confuse the ADAS system in detecting lane boundaries leading to potential false warnings or even collisions. Using this feature, the present system will be calculating the total time spent by the trucks travelling through bad road conditions.

Utilizing the United States Department of Transportation's Bureau of Transportation Statistics (BTS) database, the present system compiles information on the percentage of roads in poor condition in each state based on the International Roughness Index (IRI) metric. Additionally, the number of fatalities per 100 million vehicle miles traveled is considered. By performing a weighted average of individual ranks, the present system categorizes states into different groups ranging from worst to best road conditions. The table below shows the list of the top 5 best and worst performing States based on road surface conditions and fatalities.

| States with a higher percentage | States with lower percentage |
|---|---|
| of good quality roads | of good quality roads |
| and fewer fatalities | and higher fatalities |
| North Dakota | Hawaii |
| New Hampshire | Delaware |
| Nebraska | West Virginia |
| Minnesota | Louisiana |
| Utah | New Mexico |

4) Traffic conditions: Traffic conditions on the road are also another important factor to be considered while operating autonomous trucks. In heavy traffic conditions, there are often multiple vehicles in close proximity, which can interfere with the sensor's ability to distinguish between different vehicles. Heavy traffic conditions increase the likelihood of rear-end and front-end collisions. Under this feature, the present system will be calculating the total time spent by the trucks travelling through highly congested places.

Using the 2020 Highway Statistics from the Federal Highway Administration, the present system determines the average daily traffic per lane in urban and rural Interstate highways and principal roads. States are ranked based on traffic congestion, with higher traffic per lane leading to lower rankings. The present system performs a weighted average of individual ranks to classify states into different categories based on traffic conditions. The below table shows the top 5 States with the worst traffic in urban areas arranged in decreasing order of their average daily traffic per lane in urban Interstate highways.

| | Average daily | | Average daily | |
|---|---|---|---|---|
| | traffic per lane in | | traffic per lane in | |
| | urban Interstate | | urban principal | |
| State | highways | Rank | roads | Rank |
| California | 18220.36 | 50 | 34091.28 | 50 |
| Maryland | 15857.28 | 49 | 28155.29 | 47 |
| Florida | 14886.05 | 48 | 29807.05 | 48 |
| Connecticut | 14318.37 | 47 | 27644.77 | 46 |
| Texas | 14243.01 | 46 | 24708.51 | 39 |

With telematics data obtained from the autonomous trucks on a particular day, the present system identifies the states the truck has traveled through, and the time spent in each state. By cross-referencing this information with the road surface and traffic condition rankings, the present system determines the most traveled road and traffic conditions for that truck on that specific day. The penalty will be calculated as the percentage of total time spent traveling through bad roads and traffic conditions.

| Time spent in | Time spent in | Total | Total time spent | % of time spent |
|---|---|---|---|---|
| States with poor | States with high | duration | in bad road | travelling |
| road conditions | traffic congestion | of the trip | and traffic | in bad |
| (hours) | (hours) | (hours) | conditions | conditions |
| 1.4 | 3.4 | 8.9 | 1.4 + 3.4 = 4.8 | 4.8/8.9 = 53.9 |
| 1.3 | 1.2 | 6.3 | 1.3 + 1.2 = 2.5 | 2.5/6.3 = 39.6 |

| % of time spent travelling | | Bad road conditions and |
|---|---|---|
| in bad conditions | Weightage | traffic conditions Penalty |
| 53.9 | 1 | 53.9 |
| 39.6 | 1 | 39.6 |

### AT Score

Based on the above features the present system will be calculating the AT Score. The weightages assigned to each component were explained with examples before. Similar to the FICO score used in credit assessment, the AT Score utilizes a maximum score of 900.

Example of AT Score calculation: For example, consider an autonomous truck with ADAS system Level 3, which has a mileage of 32000 miles before commencing the trip. The other information obtained from the telematics data of the truck and other external sources are as follows (This is an assumption):
1) Duration of the trip—7.8 hours (468 minutes)
2) Nighttime driving—1.2 hours
3) Median speed—56 mph
4) Maximum speed—78 mph
5) Time spent above 75 mph—5 minutes
6) List of ADAS warnings
a. Number of Forward Collision Warnings—5
b. Number of Rear Collision Warnings—3
c. Number of Lane Departure Warnings—12
d. Number of Blind Spot Monitoring Warnings—11
e. Number of Speed Limit Alerts—8
f. Number of Automatic Emergency Braking events—0
7) Vehicle conditions
a. Fuel level state—Normal
b. Battery voltage state—Low
c. Coolant temperature state—Normal
d. Coolant level state—Low
e. Engine oil pressure state—Normal
f. Engine oil temperature state—High
g. Transmission oil temperature state—Normal
h. Cybersecurity—Normal
i. Tire pressure—Normal
8) Time spent in harsh weather conditions—48 minutes
9) Number of dangerous roads and intersections encountered—3
10) Time spent in travelling through bad road surface conditions and severe traffic congestion—94 minutes

Calculation steps: Based on the above information the penalties will be computed as follows:
1) Driving automation level—10 points (Level 3)
2) Mileage traversed—4 points (32000 miles)
3) Duration of the trip—7.8 (7.8 hours×1 point=7.8)
4) Nighttime driving—1.2 (1.2 hours×1 point=1.2)
5) Speeding penalty—14.46
i. Median speed—5.6 (56 mph×0.1 points=5.6)
ii. Maximum speed—7.8 (78 mph×0.1 points=7.8)
iii. % of time spent over speeding—1.06 (100×[5 minutes/468 minutes])
6) ADAS Warnings penalty—37.65
   i. Forward Collision Warnings—6.4 (10×[5/7.8])
   ii. Number of Rear Collision Warnings—3.8 (10×[3/7.8])
   iii. Number of Lane Departure Warnings—7.6 (5×[12/7.8])
   iv. Number of Blind Spot Monitoring Warnings—7.05 (5×[11/7.8])
   v. Number of Speed Limit Alerts—12.8 (10×[10/7.8])
   vi. Number of Automatic Emergency Braking events—0 (20×[0/7.8])
7) Vehicle conditions penalty—41
   i. Fuel level state—10
   ii. Battery voltage state—5
   iii. Coolant temperature state—10
   iv. Coolant level state—5
   v. Engine oil pressure state—10
   vi. Engine oil temperature state—5
   vii. Transmission oil temperature state—10
   viii. Cybersecurity—10
   ix. Tire pressure—10
      Vehicle conditions score=50×[75/90]
8) Harsh weather conditions penalty—20.5
   i. % of time spent in harsh weather conditions—20.5 (2×100×[48/468])
9) Dangerous roads and intersections penalty—6 (2×3)
10) Bad road conditions and traffic conditions penalty—20.08
   i. % of time spent in the bad road and traffic conditions—20.08 (1×100×[94/468])
AT Score=900−10−4−7.8−1.2−14.46−37.65−41−20.5−6−20.08
AT Score=737.81

Based on the above parameters the AT Score for this autonomous truck is 737.31. A higher AT Score indicates that the autonomous truck was operated in relatively less challenging conditions and the truck was operated safely. Currently, there is a lack of sufficient data to compare different scores and determine which scores are better or worse. As the autonomous truck industry evolves and more data becomes available, the present system can adjust the weightages assigned to each factor in the scoring system, making it more accurate in evaluating the risks posed by autonomous trucks.

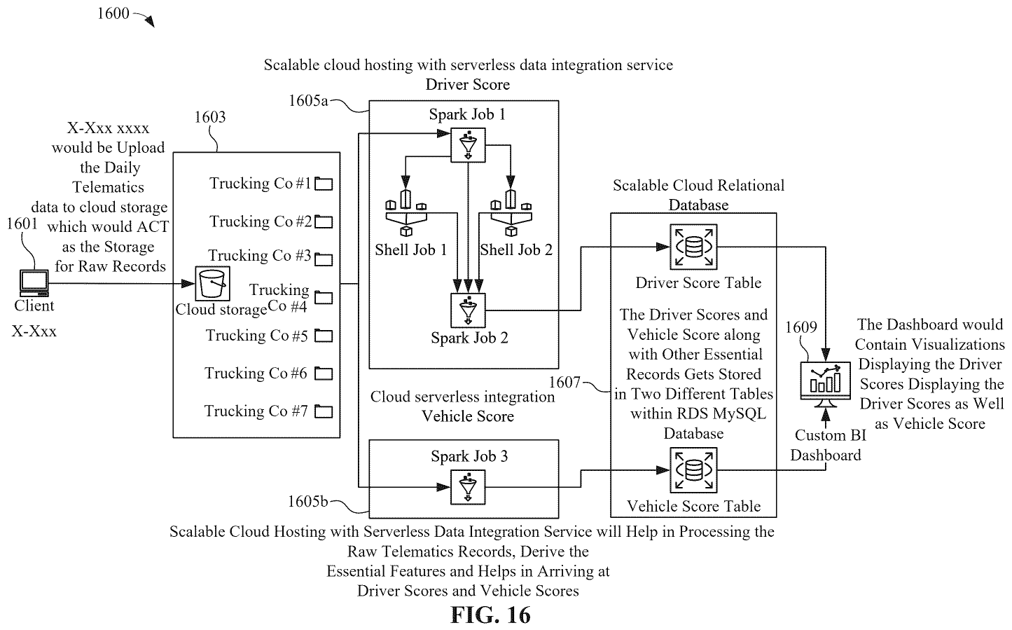

FIG. 16 illustrates a perspective view of the scalable cloud hosting architecture 1600 of the insurance system, in accordance with one or more example embodiments. The scalable cloud hosting architecture 1600 depicts the first step in the process is a telematics data partner 1601 would upload the daily telematics data to object-based scalable cloud storage 1603. Files uploaded will include driver telematics records, vehicle-related data, Hours of service violations, and camera events. So, if a driver drives on the 14th of June those corresponding records will be available to us on the 15th of June and so on in the future. There are seven different folders in the object-based scalable cloud storage 1603, and each folder would contain telematics data pertaining to a particular white label. There are seven different white-label providers for whom the telematics data partner collects data.

The next step is preprocessing, aggregation, and calculation of driver scores which would happen within the serverless data integration services 1605a, and 1605b. There are two different types of jobs within the serverless data integration service 1605a, and 1605b called latest cloud platform jobs and Python Shell jobs. The present system uses latest cloud platform jobs for handling big data and these jobs are highly resource intensive. Shell jobs are less resource-consuming jobs and the present system uses these jobs for fetching data from 3rd party APIs.

The raw telematics records would be preprocessed and aggregated and the driver-related features would be calculated within latest cloud platform Job 1. Shell job 1 helps in fetching data from 3rd party weather API and Shell job 2 will help in fetching data from 3rd party reverse geocoding API. Latest cloud platform job 2 will help in combining the results from the previous jobs, driver score calculations and risk score predictions will be made and driver scores and other necessary information will be sent to the database via this job. Latest cloud platform job 3 processes the vehicle telematics stats records, calculates the necessary features, and helps in arriving at vehicle scores. The vehicle scores would be sent to the database.

The scalable cloud hosting architecture 1600 uses scalable cloud MYSQL database 1607 for storing the processed records. There are a total of 14 tables with 2 tables each for every white label. Driver-related data along with driver scores and risk scores are stored in one table while vehicle-related features and vehicle scores are stored in the other table. Further, the scalable cloud hosting architecture 1600 would use custom interactive business intelligence (BI) and data visualization dashboards 1609 to visualize the data stored in the database. The serverless data integration service jobs are scheduled to run daily, and the records would be uploaded to the database daily and custom interactive business intelligence (BI) and data visualization dashboards would also get refreshed automatically daily. The scalable cloud hosting architecture 1600 shows the steps involved for one white label and this would be repeated for the other white labels hence there will be a total of thirty jobs scheduled to run daily.

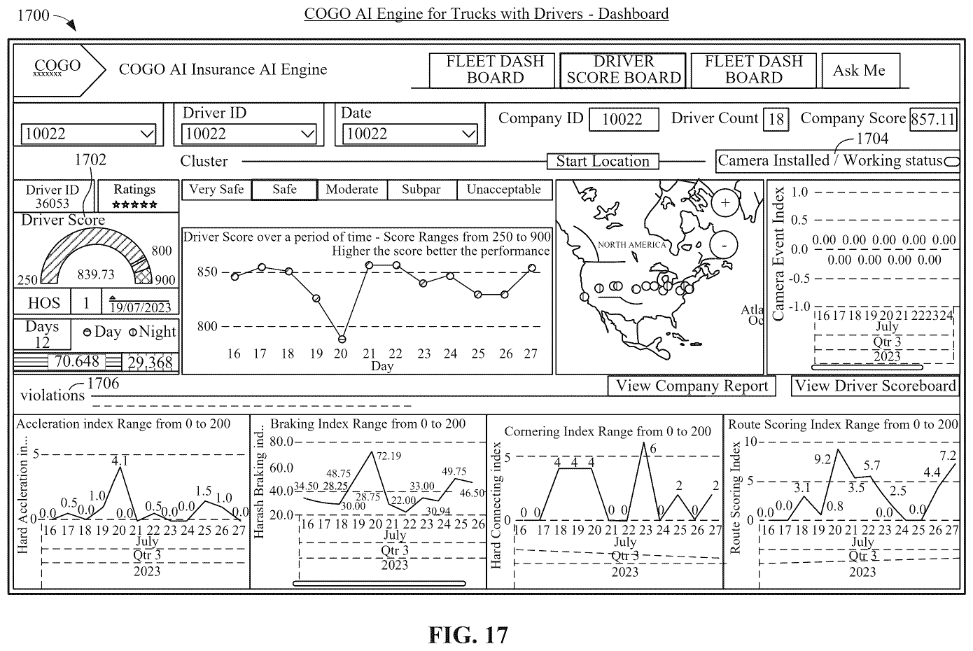

FIG. 17 illustrates an exemplary user interface of a driver scoreboard 1700, in accordance with one or more example embodiments. The driver scoreboard 1700 depicts the driver score 1702 over a period of time and the driver score ranges from 250 to 900. Further, the driver scoreboard 1700 depicts the working status 1704 of the various cameras installed in the vehicle. Additionally, the driver scoreboard 1700 depicts various violations done by the driver. These violations 1706 are depicted in graphical representations with respect to an acceleration index range from 0 to 200; a braking index range from 0 to 200; a cornering index ranging from 0 to 100; and a route scoring index ranging from 0 to 100.

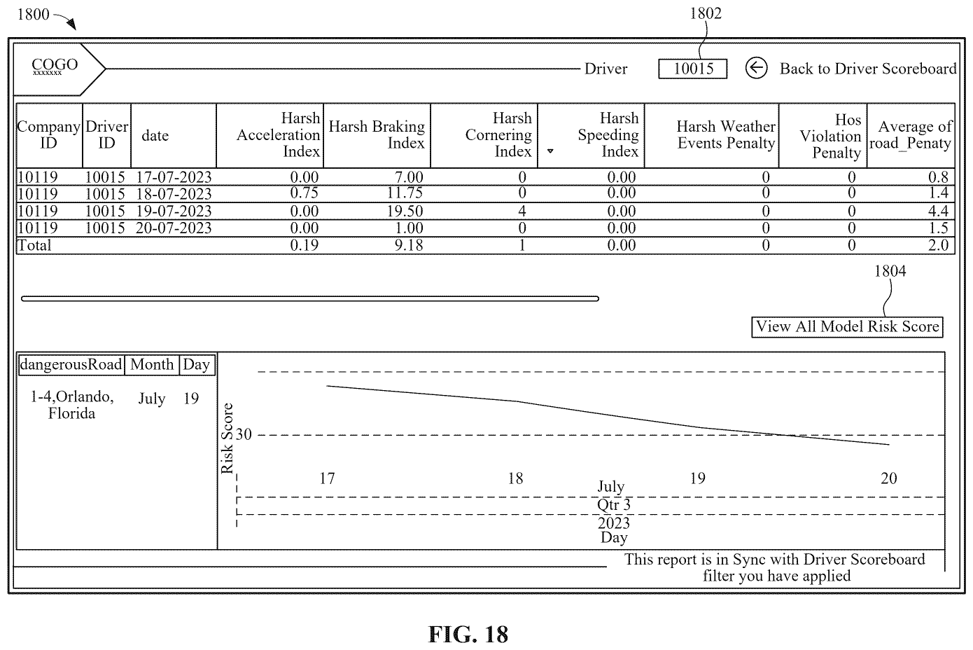

FIG. 18 illustrates a perspective view 1800 of a tabular representation of driver tools 1802 and a graphical representation 1804 of all model risk scores, in accordance with one or more example embodiments. The tabular representation of driver tools 1802 depicts various columns related to a company ID, a driver ID, a date, a harsh acceleration index; a harsh braking index; a harsh cornering index; a harsh speeding index, a harsh weather events penalty, a HOS violation penalty, and an average of road penalty. The graphical representation 1804 of all model risk scores depicts a risk score on a daily basis. The tabular representation of driver tools 1802 and a graphical representation 1804 of all model risk scores are created based on a driver scoreboard applied in the exemplary user interface of the driver scoreboard 1700.

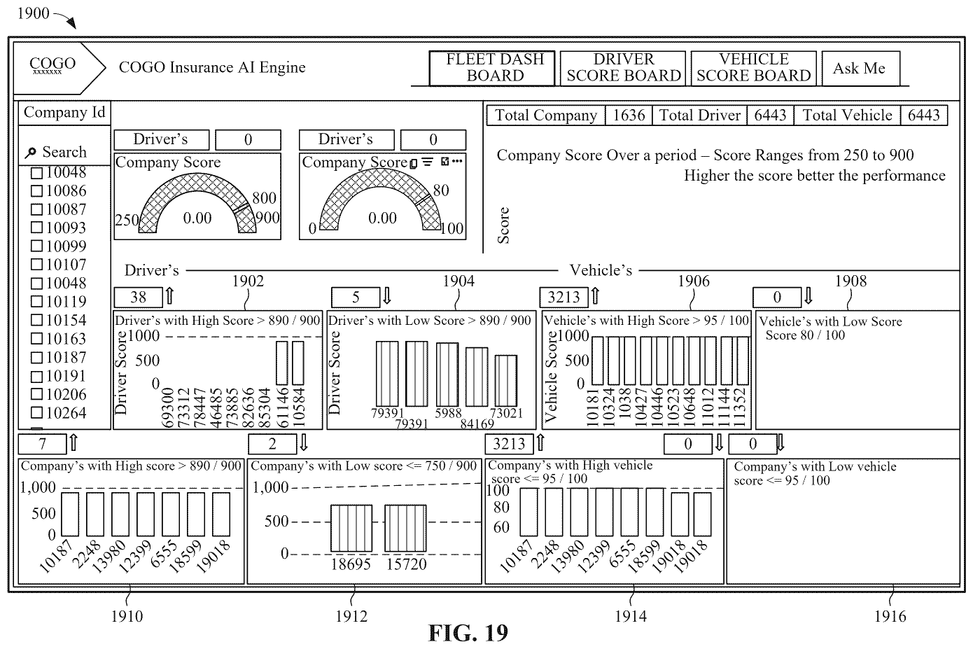

FIG. 19 illustrates an exemplary user interface of a fleet dashboard 1900, in accordance with one or more example embodiments. The fleet dashboard 1900 depicts data related to a total number of companies, total driver, and total vehicles registered on the insurance service platform. Further, the fleet dashboard 1900 depicts a company score over a period and the score ranges from 250 to 900. The higher the company score better the performance of the company. Further, the fleet dashboard 1900 depicts various graphical representations related to drivers with high scores 1902, drivers with low scores 1904, vehicles with high scores 1906, vehicles with low scores 1908, companies with high scores 1910, companies with low scores 1912, companies with high vehicle scores 1914, and companies with low vehicle scores 1916.

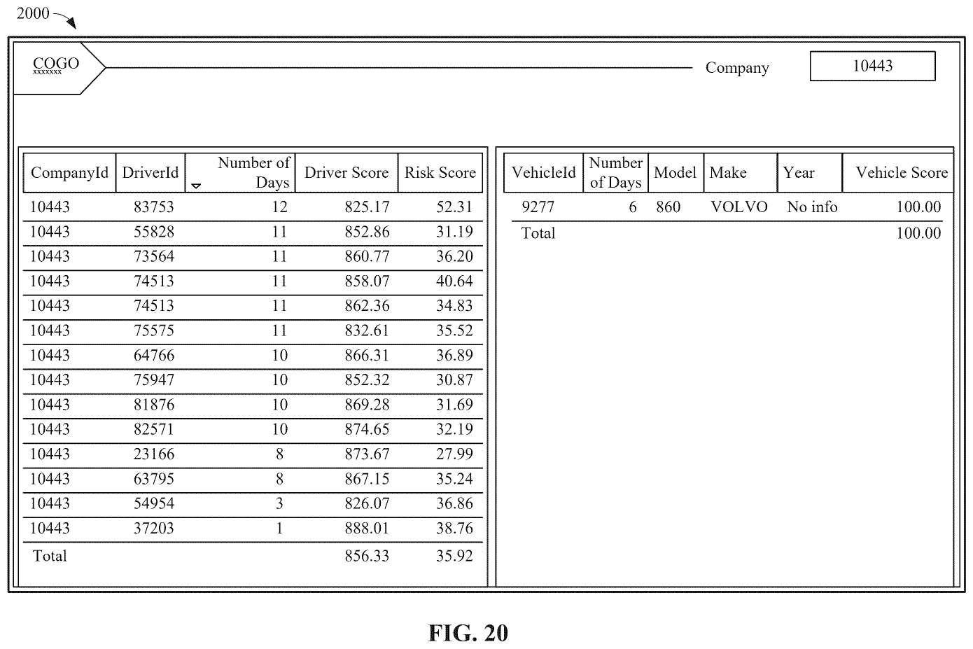

FIG. 20 illustrates a tabular representation 2000 of computations of the risk score and the vehicle score, in accordance with one or more example embodiments. The tabular representation 2000 depicts various columns of a companyID, a driverID, the number of days, the driver score, and the risk score. Finally, an average driver scores i.e. 856.33 and the average of the risk scores i.e. 35.92 are computed. Further, the tabular representation 2000 depicts various columns of a vehicleID, number of days, model, make, year, and vehicle score.

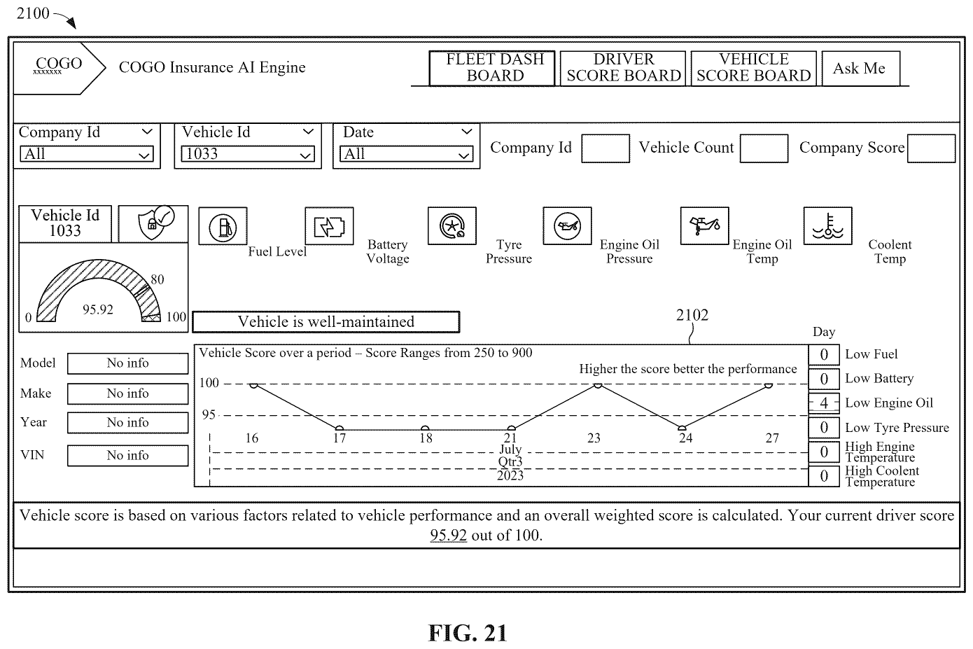

FIG. 21 illustrates an exemplary user interface of a vehicle scorecard 2100, in accordance with one or more example embodiments. The vehicle scorecard 2100 depicts the vehicle score, fuel level, battery voltage, tire pressure, engine oil pressure, engine oil temperature, and coolant temperature. The vehicle scorecard 2100 further depicts a graphical representation 2102 of vehicle score over a period and the score ranges from 250-900.

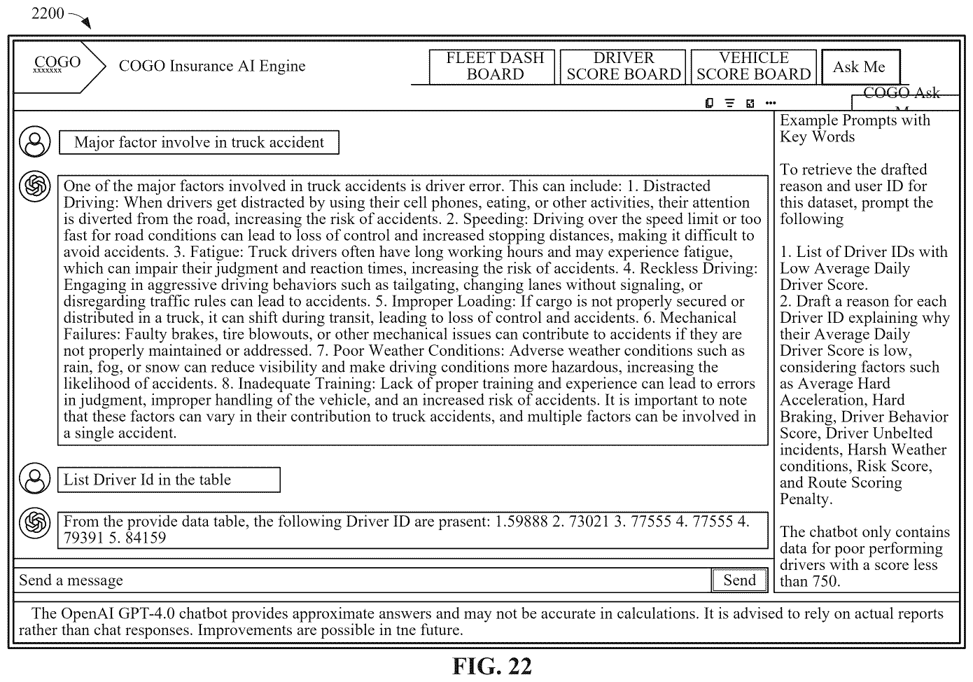

FIG. 22 illustrates an exemplary chat interface 2200, in accordance with one or more example embodiments. The exemplary chat interface 2200 depicts an automated AI-based chatbot that can be used to establish text-based communication between the present insurance system and the users.

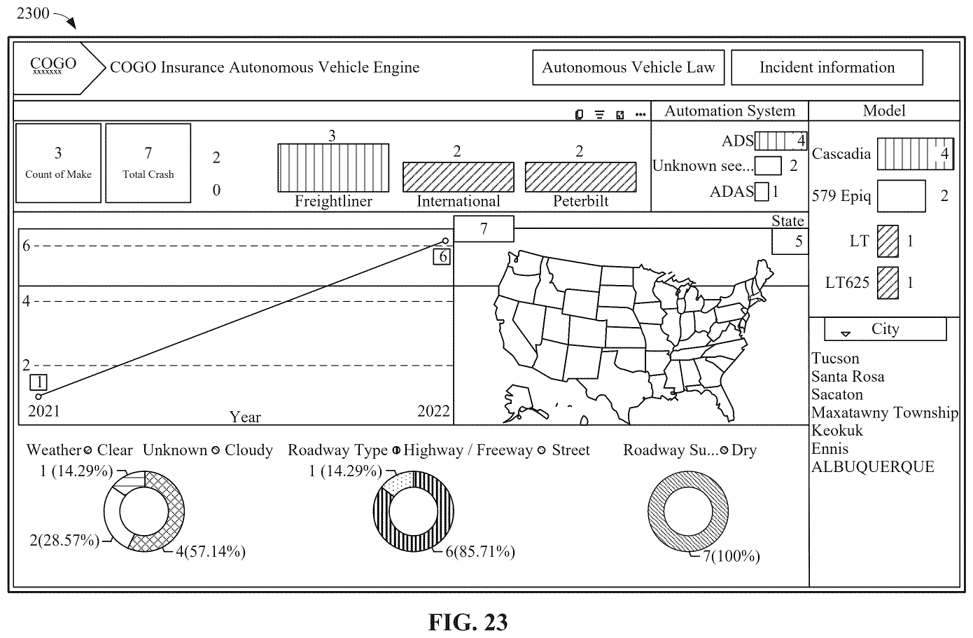

FIG. 23 illustrates an exemplary geographical user interface 2300 of autonomous vehicle law and incident information, in accordance with one or more example embodiments. The exemplary geographical user interface 2300 depicts incidents or crashes that occurred in each of the states by autonomous vehicles. The exemplary geographical user interface 2300 further depicts the details of the vehicles that violated autonomous vehicle laws in each of the states.

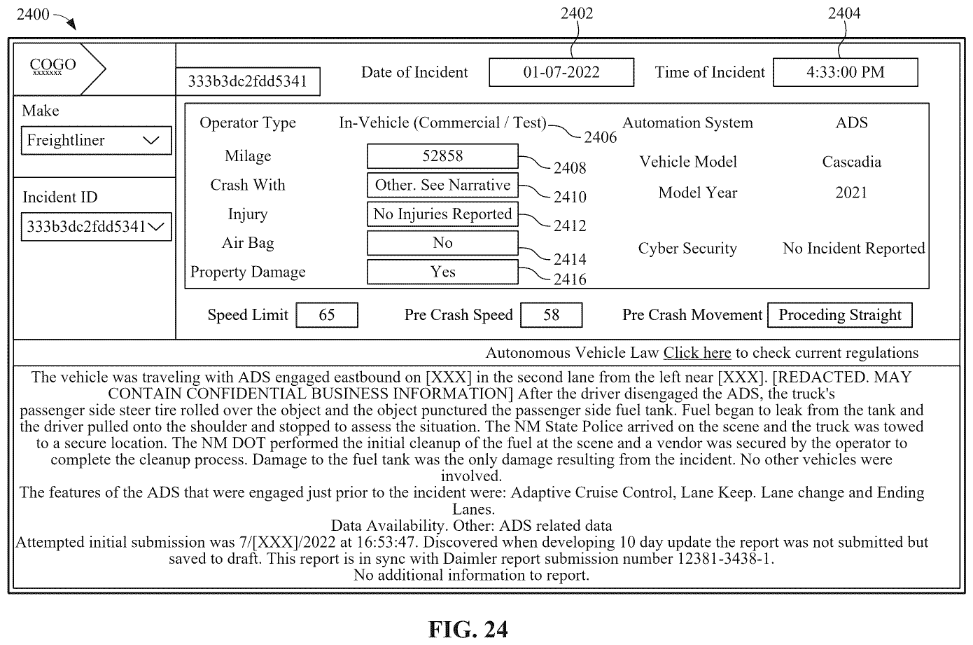

FIG. 24 illustrates an exemplary user interface 2400 of incident information, in accordance with one or more example embodiments. The exemplary user interface 2400 of the incident information depicts details related to the date of the incident 2402, time of the incident 2404, operator type 2406, mileage 2408, crash with 2410, injury 2412, airbag 2416, and property damage 2416. The exemplary user interface 2400 of the incident information further depicts details related to the speed limit of the vehicle, pre-crash speed, and pre-crash movement. Additionally, the exemplary user interface 2400 of the incident information depicts a summarized detail of the captured information.

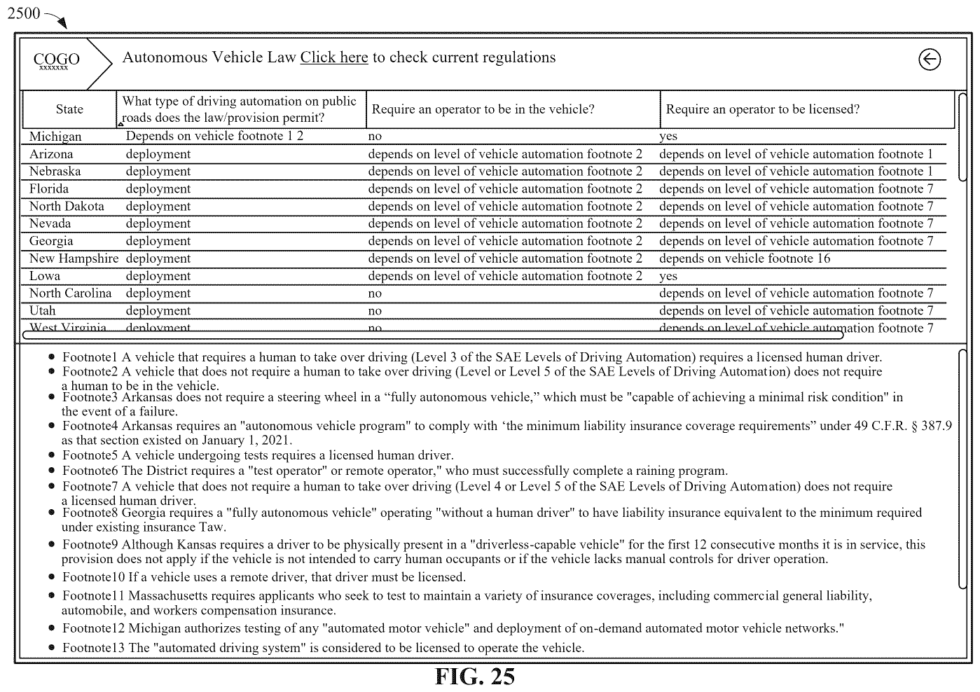

FIG. 25 illustrates an exemplary user interface 2500 of autonomous vehicle law in various states, in accordance with one or more example embodiments. The exemplary user interface 2500 of autonomous vehicle law in various states has various columns such as a list of states, details of the type of driving automation permitted on public roads, details of whether an operator is required to be in the vehicle, and details of whether an operator to be licensed. Additionally, the exemplary user interface 2500 of autonomous vehicle law in various states depicts various footnotes related to autonomous vehicle law and the permissions provided to the operators or drivers to drive autonomous vehicles.

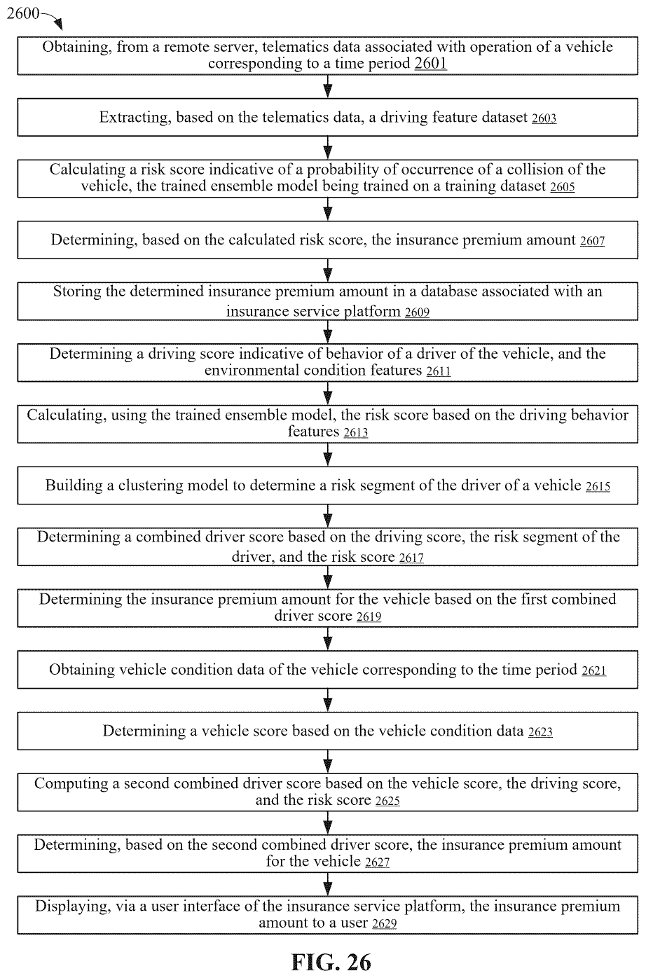

FIG. 26 is a flowchart of a computer-implemented method 2600 for determining an insurance premium amount, in accordance with one or more example embodiments. FIG. 26 is explained in conjunction with FIGS. 1-2. The computer-implemented method 2600 includes a step 2601 of obtaining, from a remote server 105b, telematics data associated with operation of a vehicle corresponding to a time period. The computer-implemented method 2600 includes a step 2603 of extracting, based on the telematics data, a driving feature dataset comprising at least one of: a driving behavior dataset, an environmental condition dataset, or a combination thereof. In additional method embodiments, the driving behavior dataset includes but is not limited to hard acceleration data, very hard acceleration data, extreme acceleration data, hard braking data, very hard braking data, extreme braking data, hard acceleration-cornering data, hard braking-cornering data, over-speeding data, driving hours data, night drive hours data, average speed data, driver camera data, and service hours violation data. In additional method embodiments, the environmental condition dataset includes but is not limited to harsh weather condition data, dangerous roads driven data, road surface data, and traffic condition data. The computer-implemented method 2600 includes a step 2605 of calculating, based on execution of a trained ensemble model 201A on the extracted driving feature dataset, a risk score indicative of a probability of occurrence of a collision of the vehicle. In additional method embodiments, the trained ensemble model 201A includes a plurality of machine learning models 201B that include but are not limited to a first gradient-boosting model 201C, a second gradient-boosting model 201D, and a neural network 201E. The trained ensemble model 201A being trained on a training dataset includes a plurality of subsamples of the driving feature dataset such that each subsample of the plurality of subsamples comprises at least: a common minority class dataset and a varying majority class dataset. In additional method embodiments, the common minority class includes data of collision events and the varying majority class includes a dataset of no collision events. The computer-implemented method 2600 includes a step 2607 of determining, based on the calculated risk score, the insurance premium amount. The computer-implemented method 2600 includes a step 2609 of storing the determined insurance premium amount in a database 105a associated with an insurance service platform 105.

The computer-implemented method 2600 includes a step 2611 of determining a driving score indicative of behavior of a driver of the vehicle, based on a weighted combination of the driving behavior features, and the environmental condition features. The computer-implemented method 2600 includes a step 2613 of calculating, using the trained ensemble model 201A, the risk score based on the driving behavior features. The computer-implemented method 2600 includes a step 2615 of building a clustering model 201F to determine a risk segment of the driver of a vehicle. In additional method embodiments, the clustering model 201F is trained based on a training dataset that comprises a plurality of driving features of different drivers collected over a period of time, to segment the different drivers into a number of segments. The computer-implemented method 2600 includes a step 2617 of determining a combined driver score based on the driving score, the risk segment of the driver, and the risk score. In additional method embodiments, the risk segment corresponds to one of: a very safe segment, a safe segment, a moderate segment, a subpar segment, and an unacceptable segment. The computer-implemented method 2600 includes a step 2619 of determining the insurance premium amount for the vehicle based on the first combined driver score. The computer-implemented method 2600 includes a step 2621 of obtaining vehicle condition data of the vehicle corresponding to the time period. In additional method embodiments, the vehicle condition data comprises one or more of a fuel level state, a battery voltage state, an engine coolant temperature state, an engine coolant level state, an engine oil temperature state, an engine oil pressure state, a transmission oil temperature state, and a tire pressure state. The computer-implemented method 2600 includes a step 2623 of determining a vehicle score based on the vehicle condition data. The computer-implemented method 2600 includes a step 2625 of computing a second combined driver score based on the vehicle score, the driving score, and the risk score. The computer-implemented method 2600 includes a step 2627 of determining, based on the second combined driver score, the insurance premium amount for the vehicle. The computer-implemented method 2600 includes a step 2629 of displaying, via a user interface of the insurance service platform 105, the insurance premium amount to a user. Thus, the computer-implemented method 2600 streamlines the determination of insurance premiums, encompasses several key steps. Initially, telematics data pertaining to a vehicle's operation within a specific timeframe is obtained from the remote server. Subsequently, a driving feature dataset is extracted from this telematics data, which includes both driving behavior and environmental condition data. Following this, a risk score is computed utilizing a trained ensemble model, which effectively predicts the likelihood of a collision. Based on this calculated risk score, the insurance premium amount for the vehicle is determined and then securely stored in a database linked to an insurance service platform. The method's complexity deepens as it also considers factors related to the driver's behavior and environmental conditions. It computes a driving score by combining various features within these domains. The trained ensemble model plays a pivotal role here, allowing for the assessment of driving behavior features. Moreover, a clustering model is developed to segment drivers into distinct risk categories, such as “very safe,” “safe,” “moderate,” “subpar,” or “unacceptable.” A combined driver score is then established, drawing from the driving score, the risk segment, and the initial risk score. The method does not stop there; it further takes into account the vehicle's condition data, encompassing parameters like fuel levels, battery voltage, and tire pressure, to compute a vehicle score. A second combined driver score is subsequently derived, factoring in the vehicle score, driving score, and risk score. Ultimately, this multifaceted approach culminates in the determination of the insurance premium for the vehicle. This calculated premium is then presented to the user through the user interface of the insurance service platform. In essence, this method aims to offer personalized insurance premium quotations by expertly integrating telematics data, driver behavior, environmental conditions, and vehicle condition, ensuring precise and data-driven insurance pricing.

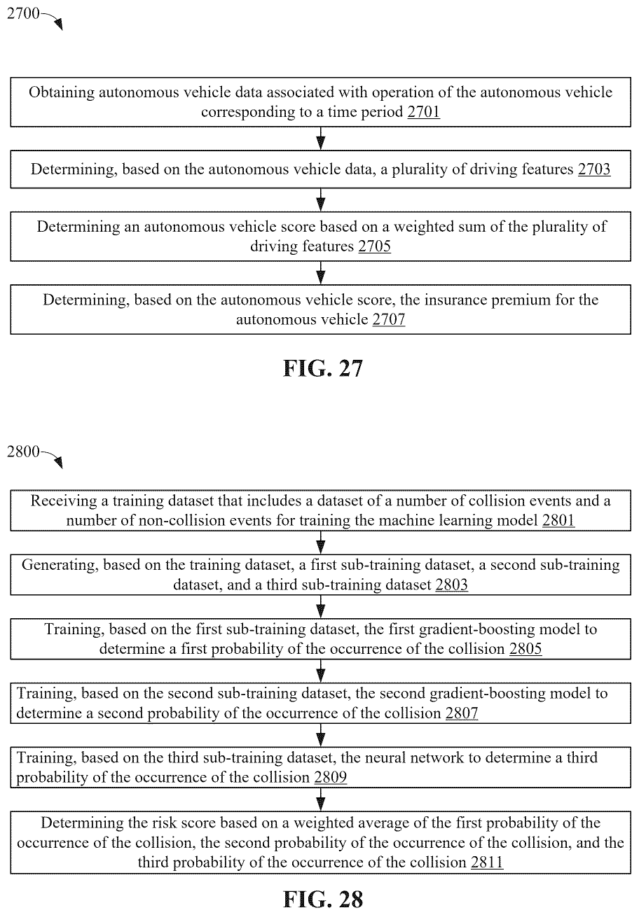

FIG. 27 is a flowchart of a computer-implemented method 2700 for determining insurance premium for an autonomous vehicle, in accordance with one or more example embodiments. FIG. 27 is explained in conjunction with FIGS. 1-2. The computer-implemented method 2700 comprises a step 2701 of obtaining autonomous vehicle data associated with operation of the autonomous vehicle corresponding to a time period from the ELD devices 109 installed in the vehicles 107. The computer-implemented method 2700 further comprises a step 2703 of determining, based on the autonomous vehicle data, a plurality of driving features by the trained ensemble model 201A. The computer-implemented method 2700 further comprises a step 2705 of determining an autonomous vehicle score based on a weighted sum of the plurality of driving features by the trained ensemble model 201A. Further, the computer-implemented method 2700 comprises a step 2707 of determining, based on the autonomous vehicle score, the insurance premium for the autonomous vehicle using a computer processor 203. Thus, in the computer-implemented method 2700, data from autonomous vehicles, obtained through ELD devices installed in these vehicles, plays a pivotal role. The system extracts a multitude of driving features by applying a trained ensemble model to the collected autonomous vehicle data. These driving features serve as the foundation for determining an autonomous vehicle score, which is calculated by taking a weighted sum of these features using the same ensemble model. This score is a critical component in evaluating the insurance premium for the autonomous vehicle. Thus, the method efficiently utilizes autonomous vehicle data to assess driving behavior and determine corresponding insurance premiums for these vehicles.

FIG. 28 is a flowchart of a computer-implemented method 2800 for training a machine learning model to determine a risk score indicative of a probability of occurrence of a collision of a vehicle, in accordance with one or more example embodiments. FIG. 28 is explained in conjunction with FIGS. 1-2. The computer-implemented method 2800 comprises, at step 2801, receiving a training dataset that includes a dataset of a number of collision events and a number of non-collision events for training the machine learning model 201B. The machine learning model 201B is based on a first gradient-boosting model 201C, a second gradient-boosting model 201D, and a neural network 201E. The computer-implemented method 2800 comprises, at step 2803, generating, based on the training dataset, a first sub-training dataset, a second sub-training dataset, and a third sub-training dataset. The computer-implemented method 2800 comprises, at step 2805, training, based on the first sub-training dataset, the first gradient-boosting model to determine a first probability of the occurrence of the collision. The computer-implemented method 2800 further comprises, at step 2807, training, based on the second sub-training dataset, the second gradient-boosting model to determine a second probability of the occurrence of the collision. Further, the computer-implemented method 2800 comprises, at step 2809, training, based on the third sub-training dataset, the neural network 201E to determine a third probability of the occurrence of the collision. The computer-implemented method 2800 comprises, at step 2811, determining the risk score based on a weighted average of the first probability of the occurrence of the collision, the second probability of the occurrence of the collision, and the third probability of the occurrence of the collision. Thus, in the computer-implemented method 2800, a comprehensive approach to predicting collision events is employed. The process commences by acquiring a training dataset that encompasses both collision and non-collision events, intended for training the machine learning model. This model, composed of a first and second gradient-boosting model and a neural network, undergoes training using three distinct sub-training datasets derived from the main training dataset. The first gradient-boosting model determines the likelihood of a collision based on the first sub-training dataset, while the second gradient-boosting model does the same using the second sub-training dataset. Simultaneously, the neural network is trained using the third sub-training dataset. Ultimately, the risk score, a crucial measure of collision probability, is calculated by taking a weighted average of the probabilities derived from these individual models. This method essentially combines the predictive capabilities of multiple models to provide a more accurate assessment of collision risk.

It will be understood that each block of the flow diagrams of the computer-implemented methods 2600-2800 may be implemented by various means, such as hardware, firmware, processor, circuitry, and/or other communication devices associated with the execution of software including one or more computer program instructions. For example, one or more of the procedures described above may be embodied by computer program instructions. In this regard, the computer program instructions that embody the procedures described above may be stored by the memory 201 of the insurance system 101, employing an embodiment of the present disclosure and executed by the computer processor 203. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flow diagram blocks.

Accordingly, blocks of the flow diagrams support combinations of means for performing the specified functions and combinations of operations for performing the specified functions for performing the specified functions. It will also be understood that one or more blocks of the flow diagram, and combinations of blocks in the flow diagram, may be implemented by special-purpose hardware-based computer systems that perform the specified functions, or combinations of special-purpose hardware and computer instructions.

Further using the methods described in the accompanying embodiments of the flowchart shown in FIGS. 26-28, which implements the various functionalities of the insurance system 101 described in FIG. 2, the driver's driving behavior is accurately identified. This is specifically advantageous in cases of determining insurance premium amounts based on the driving behavior of the driver. This is particularly useful for reducing the insurance premium amount if the drivers safely drive their vehicles, as the insurance system 101 improves the driving behavior of the driver. Thus, the insurance system uses data from devices in trucks to figure out how safely a driver is driving. If the driver is very safe, their insurance cost will be lower.

The present system and method aim to retrieve and process extensive telematics datasets, extracting specific driving and environmental features. This involves distinct data structures and extraction methods. The patent outlines a unique implementation of various machine learning models tailored specifically for predicting accident probabilities. This is not just about using existing models but involves a novel approach that could set a precedent for future systems. The use of latest cloud platform jobs, a distributed data processing method in the present environment, emphasizes the focus on efficiently handling extensive datasets, ensuring rapid data processing and analytics.

Furthermore, beyond data storage, the system optimizes database updates to enhance processing speeds. These optimizations, customized for the specific use case of the present system, represent a clear technical advancement over traditional database operations.

While specific tools and services were initially implemented in a known cloud environment, the techniques and methodologies developed are platform-agnostic. This means the solutions devised can be replicated across various cloud platforms, highlighting the system's adaptability and broad applicability. The system's training method, especially addressing class imbalances, showcases an inventive approach to machine learning training. This not only enhances predictive accuracy but also offers a novel method that could benefit the broader community.

The system provides various interfaces designed to give users insights derived from intricate data processing. Moreover, the system's ability to seamlessly integrate with various data sources, likely through platform-agnostic APIs, ensures comprehensive and up-to-date data processing. In conclusion, the patent application is deeply rooted in technical advancements tailored to a specific use case. It is more than just an abstract idea implemented on a computer; it represents a sophisticated blend of optimized data processing techniques, advanced machine learning methodologies, and platform-agnostic cloud solutions. The system's unique contributions, especially in accident probability prediction, have the potential to set industry standards, differentiating it from traditional computer-implemented methods.

The computer-implemented system and method described in this disclosure streamline the process of uploading predictions to the database. This disclosure outlines the steps for predicting risk scores using machine learning models. The prediction models in this system are trained to assess a driver's likelihood of being involved in a collision based on their recent three days of driving behavior. To do this, the system retrieves the driver's last three days of driving data from the database, including the current day. During this retrieval, the system calculates a rolling average for individual features.

Next, the system employs ten different supervised machine learning models to make predictions. These prediction probabilities are then converted into risk scores and stored in the driver scores table. For instance, if the system runs the job on September 5th, it processes the telematics records for September 4th, the previous day. During the driver score calculation job, the system compiles a dataframe (A) containing records for September 4th, which is then uploaded to the database.

As mentioned earlier, the system predicts the likelihood of a driver being involved in a collision based on the past three days of driving behavior. However, at the time of running the job, the system only has records for September 4th. To make predictions, the system also requires data from September 2nd and 3rd for the same driver. In some cases, drivers might have driven on August 20th or 21st and then again on September 4th. Consequently, the system retrieves older records from the database, calculates rolling averages for features like hard acceleration and hard braking, and stores this data in a new dataframe (B).

Now, the system has records for all dates from the database stored in a dataframe. However, the system's predictions are only needed for September 4th. So, the system filters the records for that date. For a driver, the system then has their driving behavior features for September 4th, with feature values representing the rolling average of the past three days, including September 4th.

Once the predictions are made, the system uploads the prediction data back to the database. There are two options for doing this:

1. In the first option, the database contains records for September 4th without prediction scores. The system uses an update query to add the prediction scores based on DriverID and Date using dataframe B. However, this method can be time-consuming.

2. In the second option, the system uses the append command to improve computer performance. It starts by deleting the September 4th records from the database, for example. Dataframe B contains rolling average features along with predictions. Dataframe A contains all driver behavior features for September 4th except the predictions. Dataframes A and B are merged, resulting in a combined dataframe that includes the driver's behavior features for September 4th and predictions based on their past three days of driving behavior. This combined dataframe is then appended to the database. This approach significantly reduces the time required to store the predictions in the database.

The calculating, based on execution of a trained ensemble model on the extracted driving feature dataset, a risk score indicative of a probability of occurrence of a collision of the vehicle, the trained ensemble model being trained on a training dataset comprising a plurality of subsamples of the driving feature dataset such that each subsample of the plurality of subsamples comprises at least: a common minority class dataset and a varying majority class dataset;

To further illustrate how the use of the trained ensemble model with subsamples of the driving feature dataset with a common minority class and a varying majority class data set improves computer performance, the system employs parallel machine learning models to make predictions. These prediction probabilities are then converted into risk scores and stored in the driver scores table. For instance, if the system runs the job on September 5th, it processes the telematics records for September 4th, the previous day. During the driver score calculation job, the system compiles a dataframe (A) containing records for September 4th, which is then uploaded to the database.

As mentioned earlier, the system predicts the likelihood of a driver being involved in a collision based on the past three days of driving behavior. However, in this example, at the time of running the job, the system only has records for September 4th. To make predictions, the system also requires data from September 2nd and 3rd for the same driver. In some cases, drivers might have driven on August 20th or 21st and then again on September 4th. Consequently, the system retrieves older records from the database, calculates rolling averages for features like hard acceleration and hard braking, and stores this data in a new dataframe (B). This pre-processing improves computer performance. Once the predictions are made, the system uploads the prediction data back to the database. There are two options for doing this:

1. In the first option, the database contains records for September 4th as an example without prediction scores. The system uses an update query to add the prediction scores based on DriverID and Date using dataframe B. However, this method can be time-consuming.

2. In the second option, the system uses the append command to improve computer performance. It starts by deleting the September 4th records from the database in this example. Dataframe B contains rolling average features along with predictions. Dataframe A contains all driver behavior features for September 4th except the predictions. Dataframes A and B are merged, resulting in a combined dataframe that includes the driver's behavior features for September 4th and predictions based on their past three days of driving behavior. This combined dataframe is then appended to the database. This approach significantly reduces the time required to store the predictions in the database. The combined dataframes thus improve computer performance.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A computer-implemented method for determining an insurance premium amount, comprising:
obtaining, from a remote server, telematics data associated with operation of a vehicle corresponding to a time period;
extracting, based on the telematics data, a driving feature dataset comprising at least one of: a driving behavior dataset, an environmental condition dataset, or a combination thereof;
calculating, based on execution of a trained ensemble model on the extracted driving feature dataset, a risk score indicative of a probability of occurrence of a collision of the vehicle, the trained ensemble model being trained on a training dataset comprising a plurality of subsamples of the driving feature dataset such that each subsample of the plurality of subsamples comprises at least: a common minority class dataset and a varying majority class dataset;
determining, based on the calculated risk score, the insurance premium amount; and
storing the determined insurance premium amount in a database associated with an insurance service platform.

2. The computer-implemented method of claim 1, wherein the common minority class comprises data of collision events and the varying majority class comprises a dataset of no collision events.

3. The computer-implemented method of claim 1, wherein the trained ensemble model comprises a plurality of machine learning models including at least: a first gradient-boosting model, a second gradient-boosting model, and a neural network.

4. The computer-implemented method of claim 1, further comprises:
determining a driving score indicative of behavior of a driver of the vehicle, based on a weighted combination of the driving behavior features, and the environmental condition features; and
calculating, using the trained ensemble model, the risk score based on the driving behavior features.

5. The computer-implemented method of claim 4, further comprises:
building a clustering model to determine a risk segment of the driver of the vehicle;
determining a combined driver score based on the driving score, the risk segment of the driver, and the risk score; and
determining the insurance premium amount for the vehicle based on the first combined driver score.

6. The computer-implemented method of claim 6, wherein the risk segment corresponds to one of: a very safe segment, a safe segment, a moderate segment, a subpar segment, and an unacceptable segment.

7. The computer-implemented method of claim 6, wherein the clustering model is trained based on a training dataset that comprises a plurality of driving features of different drivers collected over a period of time, to segment the different drivers into a number of segments.

8. The computer-implemented method claim 1, wherein the method further comprises:
obtaining vehicle condition data of the vehicle corresponding to the time period;
determining a vehicle score based on the vehicle condition data;
computing a second combined driver score based on the vehicle score, the driving score, and the risk score; and
determining, based on the second combined driver score, the insurance premium amount for the vehicle.

9. The computer-implemented method of claim 8, wherein the vehicle condition data comprises one or more of a fuel level state, a battery voltage state, an engine coolant temperature state, an engine coolant level state, an engine oil temperature state, an engine oil pressure state, a transmission oil temperature state, and a tire pressure state.

10. The computer-implemented method of claim 1, wherein the driving behavior dataset comprises: hard acceleration data, very hard acceleration data, extreme acceleration data, hard braking data, very hard braking data, extreme braking data, hard acceleration-cornering data, hard braking-cornering data, over-speeding data, driving hours data, night drive hours data, average speed data, driver camera data, and service hours violation data.

11. The computer-implemented method of claim 1, wherein the environmental condition dataset comprises: harsh weather condition data, dangerous roads driven data, road surface data, and traffic condition data.

12. The computer-implemented method of claim 1, further comprises displaying, via a user interface of the insurance service platform, the insurance premium amount to a user.

13. A computer-implemented method for determining insurance premium for an autonomous vehicle, comprising:
obtaining autonomous vehicle data associated with operation of the autonomous vehicle corresponding to a time period;
determining, based on the autonomous vehicle data, a plurality of driving features;
determining an autonomous vehicle score based on a weighted sum of the plurality of driving features; and
determining, based on the autonomous vehicle score, the insurance premium for the autonomous vehicle.

14. The computer-implemented method of claim 13, wherein the autonomous vehicle is a truck.

15. The computer-implemented method of claim 13, wherein the plurality of driving features comprises automation level data, driving duration data, mileage traversed data, speed data, nighttime driving data, warning data, vehicle condition data, weather data, road type data, road surface data, Hours of Service (HOS) data, and traffic data.

16. The computer-implemented method of claim 13, wherein the autonomous vehicle data comprises one or more of a fuel level state, a battery voltage state, an engine coolant temperature state, an engine coolant level state, an engine oil temperature state, an engine oil pressure state, a transmission oil temperature state, a cybersecurity state, and a tire pressure state.

17. A computer-implemented method for training a machine learning model to determine a risk score indicative of a probability of occurrence of a collision of a vehicle, comprising:
receiving a training dataset that includes a dataset of a number of collision events and a number of non-collision events for training the machine learning model, wherein the machine learning model is based on a first gradient-boosting model, a second gradient-boosting model, and a neural network;
generating, based on the training dataset, a first sub-training dataset, a second sub-training dataset, and a third sub-training dataset;
training, based on the first sub-training dataset, the first gradient-boosting model to determine a first probability of the occurrence of the collision;
training, based on the second sub-training dataset, the second gradient-boosting model to determine a second probability of the occurrence of the collision;
training, based on the third sub-training dataset, the neural network to determine a third probability of the occurrence of the collision; and
determining the risk score based on a weighted average of the first probability of the occurrence of the collision, the second probability of the occurrence of the collision, and the third probability of the occurrence of the collision.

18. An insurance system, comprising:
a memory for storing program instructions, a trained ensemble model, and telematics data associated with operation of a vehicle for a predetermined time period;
a computer processor coupled to the memory and executing the program instructions for executing a method comprising:
retrieving the telematics data associated with operation of the vehicle corresponding to a time period;
extracting, based on the telematics data, a driving feature dataset comprising at least one of: a driving behavior dataset, an environmental condition dataset, or a combination thereof;
calculating, based on execution of the trained ensemble model on the extracted driving feature dataset, a risk score indicative of a probability of occurrence of a collision of the vehicle, the trained ensemble model being trained on a training dataset comprising a plurality of subsamples of the driving feature dataset such that each subsample of the plurality of subsamples comprises at least: a common minority class dataset and a varying majority class dataset;
determining, based on the calculated risk score, an insurance premium amount; and
storing the determined insurance premium amount in the memory.

19. The insurance system of claim 18, wherein the common minority class comprises data of collision events and the varying majority class comprises a dataset of no collision events.

20. The insurance system of claim 18, wherein the trained ensemble model comprises a plurality of machine learning models including at least: a first gradient-boosting model, a second gradient-boosting model, and a neural network.
